(19) United States
(12) Patent Application Publication
(10) Pub. No.: US 2008/0072738 A1
(43) Pub. Date: Mar. 27, 2008

(54) Isomorphic Solfa Music Notation and Keyboard

(76) Inventors: James Lee Plamondon, Austin, TX (US); Ronald Frank Gorow, Studio City, CA (US)

Correspondence Address: BUCHANAN, INGERSOLL & ROONEY PC, POST OFFICE BOX 1404, ALEXANDRIA, VA, 22313-1404, US

(21) Appl. No.: 11/628,639

(22) PCT Filed: Jun. 9, 2005
(86) PCT No.: PCT/AU05/00830

§ 371 Date: Aug. 30, 2007

(30) Foreign Application Priority Data
Jun. 9, 2004 (AU) 2004903136

(51) Int. Cl. G10C 3/12; G09B 15/02

(52) U.S. Cl. 84/423 R; 84/483.2

(57) ABSTRACT

A musical notation system is provided wherein equal sized pitch intervals are represented by equal sized vertical displacements on a musical staff irrespective of the key or transportation of a musical sequence. A clef symbol and diatonic scale indicators are used to indicate the positions of diatonic pitches on the staff. A moveable Do solfa system is preferred so that musical sequences remain unchanged under transposition. The staff is easily adaptable to display various equal tempered (ET) subdivisions of the octave including 12-ET, 17-ET and 19-ET tuning systems. A system of chord notation and an isomorphic transposing keyboard is also described and claimed.

### FIELD OF THE INVENTION

The present invention relates to a system of music notation and musical instruments.

### BACKGROUND OF THE INVENTION

Musical Intervals

As is known to those versed in the musical arts, a musical “interval” is the harmonic distance between the pitches of two notes. To take the octave as an example, given a vibration with frequency f cycles per second (Hertz, abbreviated Hz), the note one octave higher will vibrate with frequency 2f Hz, with successive octaves at 4f Hz, 8f Hz, 16f Hz, and so on.

This doubling of frequency at each octave indicates a logarithmic relationship, which makes discussion and comparison of intervals complex and non-intuitive. In the late 1880's, Alexander Ellis devised a system in which the octave was divided into 1200 “cents”, with each cent denoting 1/1200^{th} of an octave. Any given interval—not just the octave—can be described as being some number of cents “wide”, or of containing or comprising this or that number of cents, without needing to state any specific pitches. Thus the concept of the “musical interval” is independent of pitch.

In modern twelve-tone equal-temperament tuning (12-ET), all twelve semi-tones in an octave are of equal width: 100 cents each.

Patterns of Intervals

Scales are specific patterns of intervals, cycling at the octave, independent of pitch. In “the major scale”, for example, the pattern of intervals is the same for any starting pitch: w-w-s-w-w-w-s, where “w” stands for “whole tone” (two semi-tones) and “s” stands for “semi-tone” (one semi-tone). Change the pitch of the first note (the tonic of the major scale), and all of the other pitches in the scale must change accordingly—but the intervals between them remain the same. Even changing to the relative minor scale does not change the cyclic sequence of intervals; only the starting point in the cycle changes (in effect, starting just before the final “w-s” at the end of the major scale's interval pattern and then wrapping around to the start of the pattern, yielding w-s-w-w-s-w-w). Thus a scale, and therefore any other sequence of notes, is simply a pattern of intervals.

Simultaneous combinations of notes—chords—are also patterns of intervals. A major triad is simply a minor third (three semi-tones) on top of a major third (four semi-tones) on top of a root. Change the pitch of the root, and the pitches of the other notes must change accordingly—but the pattern of intervals remains the same.

Underlying the pattern of intervals used to construct a major triad is an even deeper pattern, related to the patterns of intervals in scales. The diatonic scale's cyclical sequence of intervals has 7 modes, each starting the same cyclical sequence in a different place. Taking the starting note of a diatonic mode—its “tonic”—as that mode's first degree and stacking successive odd-numbered degrees one atop the other, one gets a diatonic “tertian” chord—a chord in which the inter-note intervals are always thirds (either major or minor). The same is true for the chords constructed on the harmonic minor scale, although its pattern of major and minor thirds is different from that found in the diatonic scale. Tertian chords form the basis of almost all Western tonal music.

There is a pattern in music that is deeper still, which is also exemplified by the diatonic scale. Any sub-division of the octave into a number of “semi-tones” which can be grouped into five equally-wide intervals and two equally-narrow intervals, with no semi-tones left over, can produce a recognizable diatonic scale.

In 12-ET, the wide interval is two 12-ET semi-tones wide and the narrow interval is one 12-ET semi-tone wide. In the 17-tone equally-tempered scale (17-ET), the wide interval contains three 17-ET semi-tones while the narrow interval contains only one. In the 19-tone equally-tempered scale (19-ET) the wide interval contains three 19-ET semi-tones while the narrow interval contains two. Each of these divisions of the octave—into 12, 17, or 19 “semi-tones”—produces a recognizable and musically-useful diatonic scale. Yet the division of the octave into 17 and 19 “semi-tones” has rarely been exploited in the mainstream of Western music.

In short, music is all about patterns of intervals (in rhythm). Exposing these patterns of intervals would make music easier to teach, learn, and play.

Isomorphism

The term “isomorphic” is understood to mean “being of similar shape, form, or structure”. It is derived from the Greek words “iso-”, meaning “same”, and “morph”, meaning “shape”—hence “same shape”. As previously described, the pattern of intervals that defines a given scale has the same shape—ie, is isomorphic—in all keys, as is the pattern of intervals that defines a chord built on a given mode of that scale, an arpeggio of that chord, a melody, etc. Isomorphism is thus a central concept in music (although the term is not often used in this context).

The inherent isomorphism of music is particularly pronounced in equal-temperament tuning, but is also a useful concept in non-equal-temperament tuning (such as meantone and Just Intonation). The concept of isomorphism is also applicable to scales that divide the octave into more or fewer than twelve semi-tones. The following discussion will, however, assume the use of the 12-tone equal-temperament scale unless specifically stated otherwise.

The Six Inconsistencies of Traditional Music Notation

Despite the fundamental role of intervals in music, traditional Western music notation is focused on displaying and controlling pitches rather than intervals. In traditional notation each line and space represents a specific pitch (in Hz), with the A above Middle C representing (by international treaty) the pitch 440 Hz.

FIG. 1a shows the traditional hymn “Amazing Grace” notated in the key of C using traditional notation in the treble clef. FIG. 1b shows the same song notated in the bass clef. A comparison shows that the notes from identical pitch classes are placed in different vertical locations in the treble and bass clef thus demonstrating traditional notation's inconsistency between clefs.

FIG. 1c shows the same song as that in FIG. 1a, in the same key, written in the same clef but an octave higher. A comparison shows traditional notation's inconsistency between octaves.

FIG. 1d shows the same song written in the treble clef in the key of F and comparison with FIG. 1a shows that individual pitch is notated differently, even if the intervals between them are the same. This demonstrates traditional notation's inconsistency between keys.

FIG. 2a shows a chromatic octave in traditional notation in the treble clef from middle C upwards, also showing the note that is a major third (four semi-tones) above each chromatic note, using sharps as necessary. Thus the musical interval between each pair of notes is identical and yet the spatial distance between vertical pairs is inconsistent. A completely different pattern of vertical spacing emerges from the use of flats instead of sharps as can be seen in FIG. 2b. This demonstrates traditional notation's inconsistency of interval spacing.

For historical reasons that are beyond the scope of this document, the music of some band and orchestral instruments is written in a key other than that in which it is sounded. The Bb clarinet, for example, uses music that is written a whole tone higher than that in which is it sounded. To sound a concert C, for example, the Bb clarinet's music notates a D. When it sounds a notated C, the Bb clarinet sounds a concert Bb (hence the name “Bb” clarinet). Because the Bb clarinet uses music that is not written in the same key as it sounds, it is called a “transposing instrument”. There are many other transposing band and orchestral instruments—A clarinets, F French horns, Bb and Eb saxophones, Bb trumpets, etc. Players of an Eb and Bb instrument, respectively, cannot swap parts, because they are written in the “wrong keys” for each others' instruments. This inconsistency between instruments is yet another impediment to teaching, learning, and playing musical instruments.

These five inconsistencies—between clefs, octaves, interval spacing, keys, and instruments—are well-known. New notation proposals have flourished ever since Guido d'Arezzo invented the first four-line staff (denoting the pitches of the diatonic scale in the key of C (although Guido would not have described it that way) in roughly 1026 AD. Over 500 alternative music notation schemes are described in Music Notation Modernization Association's “Directory of Music Notation Proposals” (written by Thomas S Reed, president of the MNMA, and published by Notation Research Press of Kirksville, Mo., in 1997). None of these proposals has provided a sufficiently-compelling benefit to become broadly popular.

The Chromatic Staff

According to Gardner Read's “A Source Book of Proposed Music Notation Reforms”, ISBN 0-313-25446-X, 1987), a chromatic staff of seven horizontal, parallel lines was first proposed by Roualle de Boisgelou in 1764. A variation, the Nota Graph system devised in the 1930's, uses a staff of seven lines, of which the middle line is dashed. These seven lines define six spaces in between them, providing thirteen unique vertical locations altogether. This is precisely enough to denote each of the twelve notes of the chromatic scale, plus the octave of the first note.

As shown in FIG. 3a, the bottom line of the Nota Graph staff is defined to indicate C, with each successively higher vertical location indicating a note that is a semi-tone higher than that indicated by the immediately lower vertical location.

Only the outer and middle lines are essential to this system—a three-line variation, with the four non-essential lines erased except for ledger lines, works equally well, and is far easier to read, as is shown in FIG. 3b.

When the bottom line of one such staff (denoting C) overlies the top line of another such staff (also denoting C), obscuring or replacing the line beneath, the result is two “stacked staves”. For ease of reading the inventor of Nota Graph recommended that stacked Nota Graph staves alternate between the fully-lined and three-line forms. FIG. 3c shows three such stacked Nota Graph staves.

FIG. 4 shows, on the Nota Graph staff, a chromatic octave from C to its octave. Also shown, above each chromatic note, is the note that is a major third higher. It can be seen from this Figure that the vertical spacing of each chromatic note and its major third is consistent, unlike the vertical spacing shown between notes in FIGS. 2a and 2b, as discussed above. This is not a property unique to the major third. Using the Nota Graph staff, the vertical spacing—the “shape”—of every other simple interval is equally consistent. That is, the Nota Graph staff is isomorphic.

To transpose a piece written in Nota Graph up a minor third (three semi-tones), the whole pattern of notes is simply shifted up by three vertical locations. The pattern's shape stays the same, no matter how many semi-tones it may be shifted under transposition. For example, FIG. 5a shows the song “Amazing Grace” notated on the Nota Graph staff in the key of C. FIG. 5b shows same song notated on the Nota Graph staff in the key of F. The pattern of notated intervals is consistent under transposition.

If one were to stack three staves of the three-line form of the Nota Graph staff, as shown in FIG. 6, each staff would look the same, and notes of the same pitch class would be written the same way in all clefs and octaves.

Thus, the Nota Graph staff overcomes three of the five inconsistencies of traditional notation thus far discussed—inconsistency of clefs, octaves, and interval spacing—leaving inconsistency between keys and instruments unresolved.

Inconsistency Among Divisions of the Octave

Another inconsistency, rarely recognized, is among alternative divisions of the octave. As discussed above, subdivisions of the octave into more than 12 intervals can be musically useful. Two such alternative divisions are 17-ET and 19-ET. The musical possibilities of 17-ET and 19-ET have remained largely unexplored, at least in part due to the inability of traditional musical notation and instruments to express them consistently. The piano keyboard, for example, is a physical manifestation of the 12-ET scale; its 12-note pattern of white and black keys makes it unsuitable for use with any finer division of the octave. A notational system and keyboard which were largely consistent across 12-ET, 17-ET, and 19-ET, would facilitate the exploration of the latter alternative tunings.

The Harmonic Lattice

Another under-utilized tool of music theory is a geometric construct known as the “harmonic lattice” or “tonnetz”. The harmonic lattice has one axis along which successive perfect fifths are indicated, and—in standard practice—a substantially orthogonal axis along which major thirds are indicated. Minor thirds can be connected within the plane formed by the first two axes, forming a geometric network of triangles, each representing a major or minor triad. The harmonic lattice is a great tool for visualizing harmonic relationships—triads, chord progressions, key modulations, and the like. However, it is rarely used in music education (at least in English-speaking countries), in part because it is hard to relate the harmonic lattice to traditional staff notation, chord names, and musical instruments.

### OBJECT OF THE INVENTION

It is therefore an object of the present invention to provide an improved system of musical staff notation, chord naming, keyboard note layouts, and harmonic lattices, which substantially overcomes traditional notation's six inconsistencies in clefs, octaves, intervals, keys, instruments, and octave-divisions.

### SUMMARY OF THE INVENTION

While any system of naming or numbering the simple intervals of the chromatic scale could be used, it is convenient to name them using the syllables of the tonic solfa system. This system, also known as “moveable Do”, assigns a single-syllable name to each simple chromatic interval. Each degree of the diatonic scale has a name: Do, Re, Mi, Fa, So, La, or Ti. These names are the same no matter what the key signature is. The tonic of all major keys is Do (the first degree of the major scale), whereas the tonic of all minor keys is La (the sixth degree of the major scale).

The chromatic (non-diatonic) intervals have two names each, corresponding to the sharp and flat spellings of their enharmonics. FIG. 7 shows only the flat (“descending”) names, associating each with (a) the number of semi-tones it is above Do, (b) the traditional name of the interval, and (c) a pitch class, based on the assumption that Do is C.

There is no international standard (or, alternatively, there are many conflicting proposed standards) for the specific names of the intervals in tonic solfa. Similar systems such as North Indian sargam, or number-based systems (eg, 0-11 for 12-ET), are used for similar purposes. The present invention does not depend on the specific names used for those intervals, although the preferred embodiment uses the interval names indicated herein.

Tonic solfa is commonly used in modern music education using the world's most easily-transposable musical instrument: the human voice. The well-known Kodaly system for music education is based on tonic solfa.

The term “solfege” is used herein to refer to “fixed Do”, in which Do always refers to some octave of “concert C” (that is, C in “concert tuning”, in which the first A above middle C has the frequency 440 Hz). No definitions of “solfa” and “solfege” are used consistently in the musical literature. The above definitions will be used consistently within this document to minimize ambiguity.

Thus, the invention relates to a musical staff including:
a. a first axis on which time is represented;
b. a second axis substantially perpendicular to said time axis on which the width of musical intervals is represented with a continuous implied scale;
c. a means of indicating on said second axis the unique location of the interval “unison”;
d. a means of indicating on said second axis the unique location of the interval one octave higher than unison; and
e. note lines substantially parallel to said time axis which subdivide the space between said unison location and said octave location into a number of unique note locations that is equal to the number of divisions of the octave plus one, including note lines on said unison location and on said octave location, wherein each said note line is counted as one of said unique note locations, and
   i. for even-numbered divisions of the octave,
      1. said note lines are equally spaced, and
      2. the space between each pair of said lines is counted as one of said unique note locations, and
   ii. for odd-numbered divisions of the octave, said note lines are proportionately spaced, such that the space between any given pair of said note lines is wide enough to contain either zero, one, or two said unique note locations.

Preferably, the unison octave locations are indicated by a clef symbol or a portion thereof and more preferably the unison location is associated with a specified degree of the diatonic scale's Ionian mode, in particular the first degree.

The invention also relates to a musical staff in which said clef separates a portion of said staff along said time axis from the remainder of said staff along said time axis such that:
i. said note lines extend from the start of said time axis into the body of said clef;
ii. a subset of said note lines extend continuously beyond said clef; and
iii. the remaining said note lines extend discontinuously beyond said clef as ledger lines.

In the preferred embodiment, isomorphic solfa music notation uses all aspects of traditional Western musical notation except for the traditional staves, clef signs, key signatures and chord names. The interpretation of rhythmic notation, for example, is exactly the same as in traditional notation.

In another embodiment, the distinction between filled and unfilled note-heads—which in traditional rhythmic notation is used solely to distinguish the duration of whole and half notes from quarter and shorter notes—could be used to distinguish diatonic notes from non-diatonic notes, in which case an alternative means of distinguishing whole and half notes from quarter and shorter notes would be required. One such means might be elongating the whole and half notes' note-heads, such that half notes' note-heads were twice the width of quarter notes, and whole notes' note-heads were four times the width of quarter notes. The diatonic notes heads would preferably be filled and the non-diatonic notes be unfilled in this embodiment, with the coloration of other aspects of the present invention (scale dots, keyboard buttons, etc) colored correspondingly, because filled note-heads are easier to see on the staff, and diatonic notes are more common in Western music than non-diatonic notes, so making diatonic notes easier to see maximises readability. However, the opposite convention is an equally-valid embodiment of the present invention.

It is preferred that the time line representing the passage of time consists of seven equally spaced parallel horizontal lines which create unique vertical locations. These seven equally spaced parallel horizontal lines create a staff which can be modified such that the line indicating the interval of a tritone from Do is dashed while all other lines are solid. It is also possible for the staff to be modified so that only the unison (Do) and tritone lines continue to the right of the clef. In this instance ledger lines are used to represent notes falling on the omitted lines beyond the clef. Furthermore, the notation system allows for the presence of more than one staff, and in such a case, the more than one staves can be stacked.

The staff or staves can be presented in partial form, with those lines and spaces on which no notes fall being elided.

One way of distinguishing the unique locations of the notes of a chromatic scale is by use of a clef symbol. The clef symbol preferably takes the form of a crescent in which the tips of the crescent shape indicate where Do is notated on the staff or staves, regardless of the pitch of Do.

The unique location of the notes of a chromatic scale may also be indicated in a three line form of the staff by a solid line for Do and a dashed line for Do's tritone, and any octaves thereof.

The notation system also includes tonic symbols which can take the form of shapes or note names. Octave indicators can take the form of numerals and may be based upon the MIDI standard. The octave indicators can also be used to indicate relative octave.

The invention also relates to a musical staff with 13 unique note locations, appropriate for notating a 12-ET scale. A musical staff with 18 unique note locations appropriate for notating a 17-ET scale is also envisaged, as is a musical staff with 20 unique note locations appropriate for notating a 19-ET scale.

The musical staff for a 12-ET scale preferably has note locations associated with the tonic solfa syllables Do, Ra, Re, Me, Mi, Fa, Se, So, Le, La, Te, Ti and Do respectively, from said unison location upwards. The 17-ET scale preferably has note locations associated with the tonic solfa syllables Do, Di, Ra, Re, Ri, Me, Mi, Fa, Fi, Se, So, Si, Le, La, Li, Te, Ti and Do respectively, from said unison location upwards, and the 19-ET scale preferably has note locations associated with the tonic solfa syllables Do, Di, Ra, Re, Ri, Me, Mi, My, Fa, Fi, Se, So, Si, Le, La, Li, Te, Ti, Du, and Do respectively, from the unison location upwards.

Alternatively, the musical staff for the 12-ET scale can have note locations associated with the integers 0-11, from said unison location upwards, with said octave location also associated with 0. The 17-ET scale can have note locations associated with the integers 0-16, from said unison location upwards, with said octave location also associated with 0 and the 19-ET scale can have note locations associated with the integers 0-18, from said unison location upwards, with said octave location also associated with 0.

The invention also provides a method for representing a musical sequence and/or combination, the method including the steps of:
a. determining a note to be represented;
b. writing said note using a music notation system as defined above; and repeating (a) and (b) until the musical sequence and/or combination is complete.

This method can be used to transcribe an existing musical sequence and/or combination from traditional or alternative notation. The determination of the note to be represented can be done visually, aurally, or electronically. The method can also be used to create an original musical sequence and/or combination.

The invention also provides for a medium which is blank except for one or more of the present invention's staves, upon which a musical sequence and/or combination can be represented using the music notation system defined above. Furthermore, the music notation system can be used to represent a musical sequence and/or combination in electronic form, for example on a computer screen. A musical sequence and/or combination can also be stored electronically and then viewed, printed or edited.

The system also relates to an isomorphic solfa sequencer notation system including:
a. a first axis on which time is represented;
b. a second axis substantially perpendicular to said time axis on which the width of musical intervals is represented;
c. a means of indicating on said second axis the unique location of the interval “unison”;
d. a means of indicating on said second axis the unique location of the first octave higher than said unison location;
e. lines substantially parallel to said time axis which intersect said second axis equally subdividing the space between said unison location and said octave location into a number of note spaces equal to a number of divisions of the octave;
f. the placement of bars within said note spaces indicating by their continuous presence the sounding, and by their absence the silence, of notes corresponding with said note spaces, relative to unison.

The invention also relates to a system of displaying and/or accessing musical intervals, including
a. the geometry of an isomorphic note layout,
b. fixed locations for the degrees of the diatonic scale, and
c. electronic and/or vocal transposition of pitches to scale degrees.

This system is embodied in a number of different ways.

The invention includes an instrument suitable for teaching a student to play a musical sequence and/or combination notated according to the above defined notation system. Particularly, an isomorphic keyboard is described which includes solfa names on the instrument's note-controlling elements (usually buttons). Alternatively, the buttons may be labeled with symbols, colors or other means by which the student develops an association between the keyboard's keys and solfa intervals rather than pitches. Further, the buttons may be left entirely blank, or colored only according to the piano's traditional two-colored diatonic-chromatic categorization, but still included under this invention if the associated instructional material can reasonably be expected to form, in the student's mind, an intimate association between specific buttons and specific intervals rather than specific pitches.

More particularly, the invention relates to a musical keyboard including:
a. an isomorphic layout;
b. a means of electronic transposition;
c. indicia to distinguish relative to the current electronically-transposed key:
   i. each unique degree of the current diatonic scale; or
   ii. each unique degree of the chromatic scale; or
   iii. a two-way categorization into diatonic notes and non-diatonic notes.

The invention also includes a method of notating chord symbols. Particularly, the diatonic minor second, major second, minor third, major third, and perfect fourth are each assigned a specific single-character symbol. A string composed of such symbols can then be appended to the name of the root note, with each successive symbol indicating the interval between the successive notes in the chord, starting from the root. The name of the root note could be a pitch class name, such as Bb, or an interval name, such as Do. The string resulting from concatenating the root note name and interval symbols is below called a “chord symbol”, or sometimes a “chord name”, which are understood to mean the same thing.

In particular, the system of chord notation includes:
a. a unique symbol for each of the simple chromatic intervals from the minor second to the perfect fifth, in which each symbol is a mnemonic for either
   i. the shape of the interval on a specific isomorphic keyboard; or
   ii. the number of 12-ET semitones in the interval; and
b. placing these interval symbols in sequence from lowest pitch to highest pitch.

The invention also relates to a musical keyboard in which the isomorphic keyboard is laid out such that:
a. at least two lines (“P5 lines”) are drawn to connect keyboard locations which sound successive perfect fifths, said at least two lines being separated by a major third;
b. at least two lines (“M3 lines”) are drawn to connect keyboard locations which sound successive major thirds, each intersecting said at least two said P5 lines;
c. at least two lines (“m3 lines”) are drawn to connect keyboard locations which sound successive minor thirds, each intersection said at least two said P5 lines;
d. forming a lattice such that at least two triangles are bounded by the intersection P5 lines, M3 lines and m3 lines;
   wherein the notes of the keyboard corresponding to the vertices of each said triangle form a major or minor triad.

The isomorphic keyboard's locations are preferably associated with intervals such that the resulting lattice is the same in all keys.

### BRIEF DESCRIPTION OF THE DRAWINGS

FIG. 1a shows the song “Amazing Grace” notated in the key of C using the traditional treble clef.

FIG. 1b shows the song “Amazing Grace” notated in the key of C using the traditional bass clef.

FIG. 1c shows the song “Amazing Grace” notated in the key of C using the traditional treble clef one octave higher than shown in FIG. 1a.

FIG. 1d shows the song “Amazing Grace” notated in the key of F using the traditional treble clef.

FIG. 2a shows a chromatic octave in traditional treble clef from middle C upwards, also showing the note that is a major third above each chromatic note using sharps as necessary.

FIG. 2b shows a chromatic octave in the traditional treble clef from middle C upwards, also showing the note that is a major third above each chromatic note using flats as necessary.

FIG. 3a shows the pitches associated with the vertical locations on the Nota Graph staff.

FIG. 3b shows the pitches associated with the vertical locations on the Nota Graph staff in three-line form.

FIG. 3c shows three stacked octaves of the Nota Graph staff, alternating between fully-lined and three-line form.

FIG. 4 shows a chromatic octave on Nota Graph staff from C upwards, also showing the note that is a major third above each chromatic note.

FIG. 5a shows the song “Amazing Grace” notated in the key of C using the Nota Graph staff.

FIG. 5b shows the song “Amazing Grace” notated in the key of F using the Nota Graph staff.

FIG. 6 shows three stacked octaves of the Nota Graph staff in three-line form.

FIG. 7 shows a table relating the solfa names of the chromatic scale (descending) to traditional interval names, intervals in the number of semi-tones and example pitch classes.

FIG. 8a shows an embodiment of the isomorphic solfa staff.

FIG. 8b shows the isomorphic solfa staff with the solfa intervals labeled.

FIG. 9a shows an alternative embodiment of the isomorphic solfa staff.

FIG. 9b shows an alternative embodiment of the isomorphic solfa staff with the solfa intervals labeled.

FIG. 10 shows two stacked authentic isomorphic solfa staves.

FIG. 11 shows two stacked plagal isomorphic solfa staves.

FIG. 12 shows the song “Amazing Grace” notated on a plagal-form isomorphic solfa staff.

FIG. 13 shows an example of a tonic indicator.

FIG. 14 shows the song “Amazing Grace” notated on a plagal-form isomorphic solfa staff with an alternative tonic indicator.

FIG. 15 shows the song “Amazing Grace” notated on a plagal-form isomorphic solfa staff with an alternative tonic indicator.

FIG. 16 shows the song “Amazing Grace” notated on a plagal-form isomorphic solfa staff with an alternative tonic indicator.

FIG. 17 shows the song “Greensleeves” in traditional notation.

FIG. 18 shows the song “Greensleeves” in isomorphic solfa notation, in an unspecified minor key.

FIG. 19 shows the song “Greensleeves” in isomorphic solfa notation, in the key of A minor.

FIG. 20 shows the chromatic scale in circular form.

FIG. 21 shows the diatonic scale in circular form.

FIG. 22 shows the song “Amazing Grace” notated on a plagal-form isomorphic solfa staff with an octave indicator.

FIG. 23 shows the song “Amazing Grace” notated on a plagal-form isomorphic solfa staff with a tonic and an octave indicator.

FIG. 24 shows two staves indicating their relative octaves.

FIGS. 25a to 25f show scale indicators for Diatonic, Ionian Mode, Aeolian Mode, Harmonic Minor, Neapolitan Minor, and Pentatonic scales respectively.

FIG. 26a shows a minor scale notated on two and a half stacked authentic isomorphic solfa staves.

FIG. 26b shows an alternative representation to FIG. 26a.

FIG. 26c shows a further alternative representation to FIG. 26a.

FIG. 27 shows the Wicki/Hayden keyboard labeled with pitches.

FIG. 28 shows the Wesley keyboard labeled with pitches.

FIG. 29 shows the Wicki/Hayden keyboard with solfa labeled keys.

FIG. 30a shows the Wesley keyboard solfa labeled keys.

FIG. 30b shows a three-octave solfa-labeled Wicki/Hayden keyboard displaying the Do-mode's diatonic sequence of thirds over two octaves.

FIG. 30c shows the relationship between the isomorphic keyboard and staff.

FIG. 31 shows a harmonic lattice oriented to match an isomorphic keyboard.

FIG. 32 shows a harmonic lattice oriented to match an isomorphic solfa keyboard.

FIG. 33 shows the geometric relationships among an isomorphic solfa keyboard, staves, lattice, and chord symbols.

FIG. 34 provides a list of transposing instruments indicating the pitch they produce when playing a notated C, the number of semi-tones away from concert pitch that their music is notated and the note that must be notated for them to sound a concert C.

FIG. 35 shows the concert C major scale on the isomorphic solfege staff.

FIG. 36 shows the concert C major scale written on the isomorphic solfege staff for a Bb instrument.

FIG. 37 shows the concert C major scale written on the isomorphic solfege staff for an Eb instrument.

FIG. 38 shows the concert C major scale written on the isomorphic solfege staff for an F instrument.

FIG. 39 shows the concert C major scale written on the isomorphic solfege staff.

FIG. 40 shows the concert C# major scale written on the isomorphic solfege staff.

FIG. 41 shows an isomorphic solfege staff with a boxed “CC” on the Do-line.

FIG. 42 shows a fully-lined 17-ET isomorphic staff.

FIG. 43 shows a fully-lined 19-ET isomorphic staff.

FIG. 44 shows a partially-lined 19-ET isomorphic staff.

FIG. 45 shows the diatonic scale on a partially-lined 19-ET isomorphic staff.

FIG. 46 shows a fully-lined 19-ET isomorphic staff with over-sized note-heads.

FIG. 47 shows a partially-lined 19-ET isomorphic staff with over-sized note-heads.

FIG. 48 shows a partially-lined 17-ET isomorphic staff.

FIG. 49 shows the diatonic scale on a partially-lined 12-ET isomorphic staff.

FIG. 50 shows the diatonic scale on a partially-lined 17-ET isomorphic staff.

### DESCRIPTION OF PREFERRED EMBODIMENT

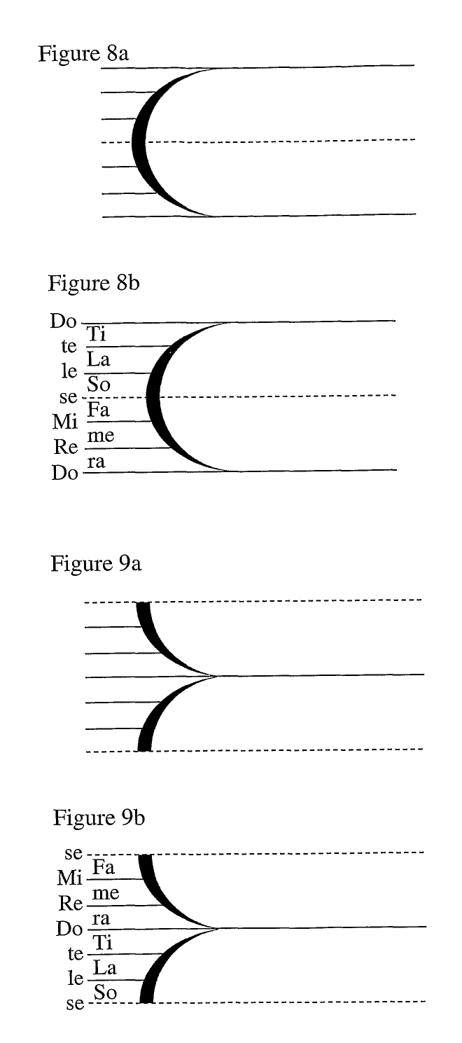

FIG. 8a shows an embodiment of the isomorphic solfa staff. A unique clef symbol distinguishes it from the Nota Graph staff and from traditional notation. In this embodiment, to the left of the clef symbol, the staff is fully-lined; to the right of the clef symbol, the staff is of three-line form.

Instead of having each vertical location indicate one of the chromatic scale's pitches, as the Nota Graph staff does, the vertical locations on the isomorphic solfa staff denote the chromatic scale's simple intervals. For example, the isomorphic solfa staff has a unique vertical location for Do—but not for C. C can be anywhere on the staff, depending on its interval from the tonic of the current key.

In FIG. 8b the isomorphic solfa staff is shown with the solfa intervals indicated by each unique vertical location labelled with their solfa names. The name-labels are not part of the staff.

In the preferred embodiment, the thirteen unique vertical locations of the staff are labelled, from bottom to top, Do, Ra, Re, Me, Mi, Fa, Se, So, Le, La, Te, Ti, and Do. Do is indicated in the preferred embodiment by a solid line, whereas Se is indicated in the preferred embodiment by a dashed line. This embodiment is said to be in “authentic” form—that is, it shows the range between the Do-line and its immediately-higher octave.

Thus the 12-ET isomorphic solfa staff's thirteen unique vertical locations (lines and spaces) from the bottom Do-line to the top Do-line uniquely represent each 100-cent interval from 0 to 1200.

One embodiment of an isomorphic solfa clef symbol is shown in FIGS. 8a and 8b. The tips of its crescent clearly indicate the staff's Do-lines. In the preferred embodiment, a single note of the chromatic scale is uniquely and consistently indicated by the clef symbol. Indicating Do is preferred. Clefs that indicate any other proper subsets of the chromatic notes are also embodiments of the present invention.

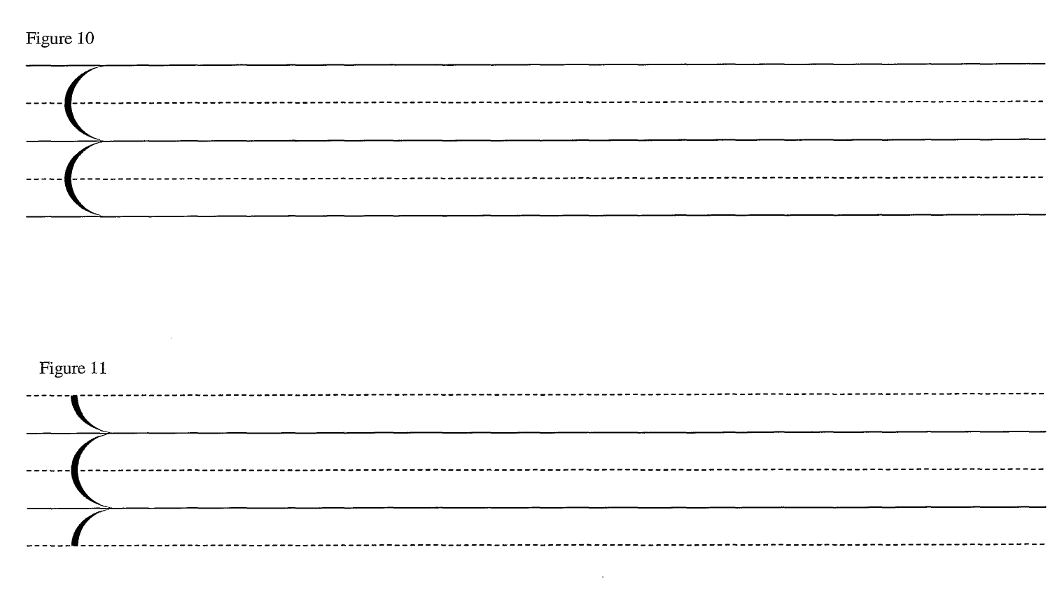

FIGS. 9a and 9b show an alternative form of the same isomorphic solfa staff, showing a range centred on the Do-line. It is the “plagal” form of the same embodiment of the isomorphic solfa staff and clef symbol shown in FIGS. 8a and 8b. FIG. 10 shows two stacked authentic-form isomorphic solfa staves. FIG. 11 shows two stacked plagal-form isomorphic solfa staves.

The authentic and plagal forms of the staff are what is left when a song in Ionian mode, with a single-octave range, is notated on two stacked authentic staves, and the unused portion(s) of the staves is erased. The staff and clef are the same in both cases; the only thing that changes is the portion(s) of the stacked staves that is erased. The same process can be used to produce single-octave views of the same stacked pair of staves using any tonic, not just Do.

Tonic Indicators

Atonal music, by definition, has no tonic (tonal centre). For atonal music, no tonic indicator is necessary. The use of solfa syllables to name the chromatic intervals need not imply any tonality. A chromatic staff is ideal for 12-ET atonal music. The rest of this discussion presumes that the music being notated is tonal (has a tonic).

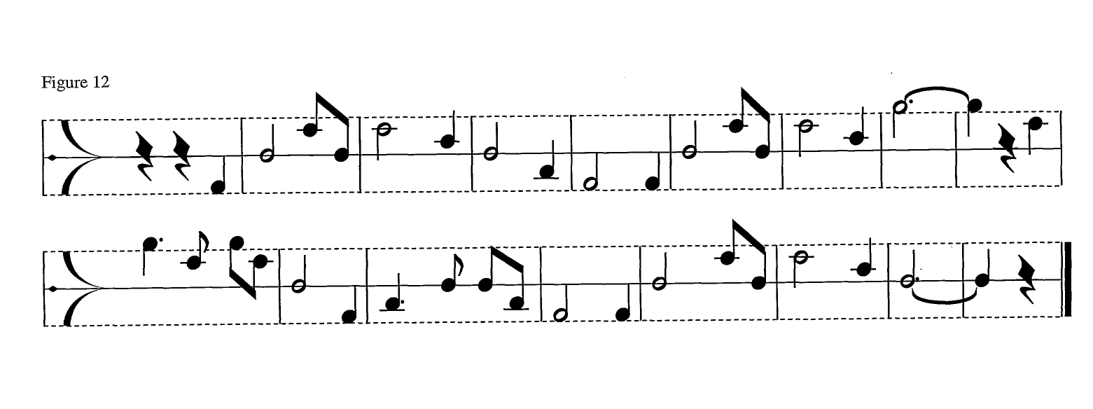

FIG. 12 shows the song “Amazing Grace” notated on a plagal-form isomorphic solfa staff. This figure shows one embodiment of a tonic indicator—a diamond-shaped symbol placed on the Do-line, indicating that Do is the tonic. This tells the reader that the song is to be played in an unspecified major key.

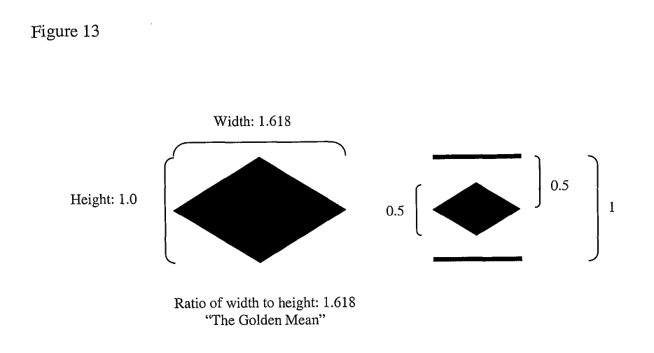

In one embodiment, as shown in FIG. 13, the diamond shape's width-to-height ratio is 1.618:1 (the Golden Mean) and its height is one-half of the width of the gap between adjacent lines in the isomorphic solfa staff. The tonic indicator should fill no more of the vertical height of the gap than this, else it may bump up against the scale indicators, discussed below. It could be smaller, at the risk of being less clearly distinct from the scale indicators.

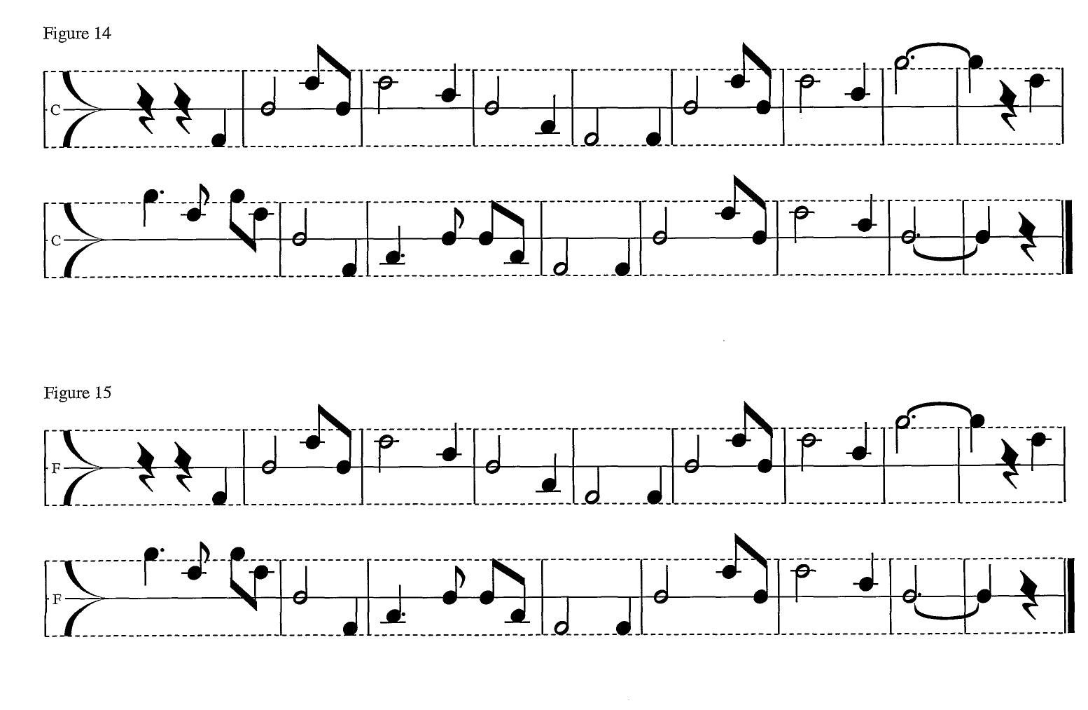

FIG. 14 shows the song “Amazing Grace” notated on a plagal-form isomorphic solfa staff. The note-name C placed on the Do-line is an alternative embodiment of the tonic indicator, indicating that Do is the tonic—that is, the song is in a major key—and that the pitch class associated with Do is C. This tonic indicator tells the player that the song is to be played in the key of C Major. In this embodiment, the tonic-indicating letter C has a white background to obscure the underlying Do-line, making the tonic-indicating letter easier to read.

FIG. 15 shows the same song; the note-name F placed on the Do-line indicates that the song is to be played in F major.

FIG. 16 shows the same song; the note-name F# placed on the Do-line indicates that the song is to be played in F# major.

The notation of the notes in the song “Amazing Grace” is identical in FIGS. 12, 14, 15 and 16. The tonic indicator is the only thing that changes. This shows that isomorphic solfa notation is consistent across key signatures (“auto-transposing”), in addition to being consistent across clefs, octaves, and intervals as previously discussed.

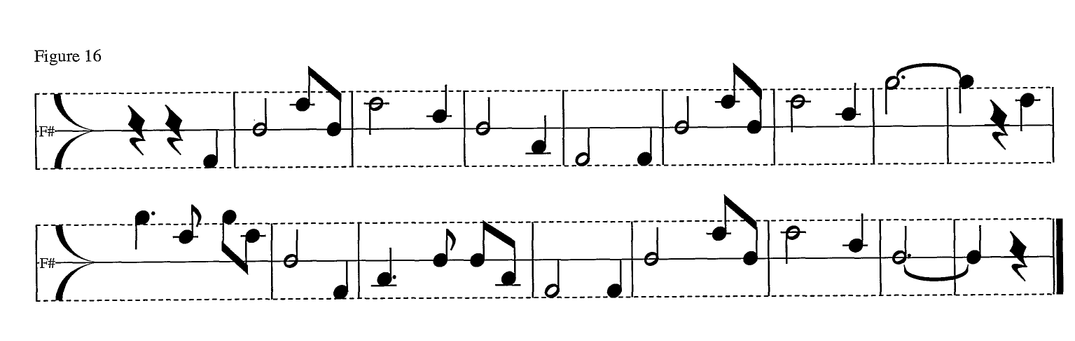

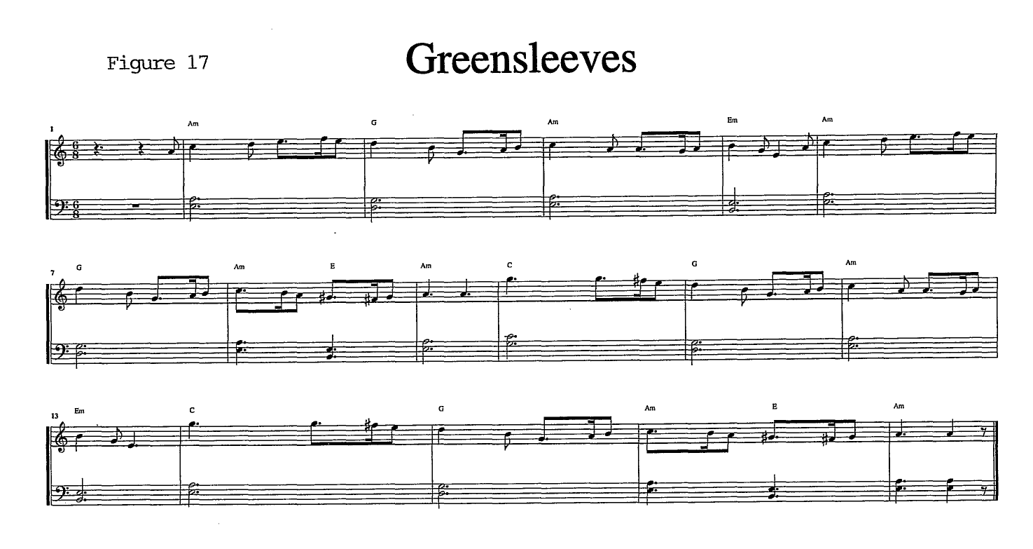

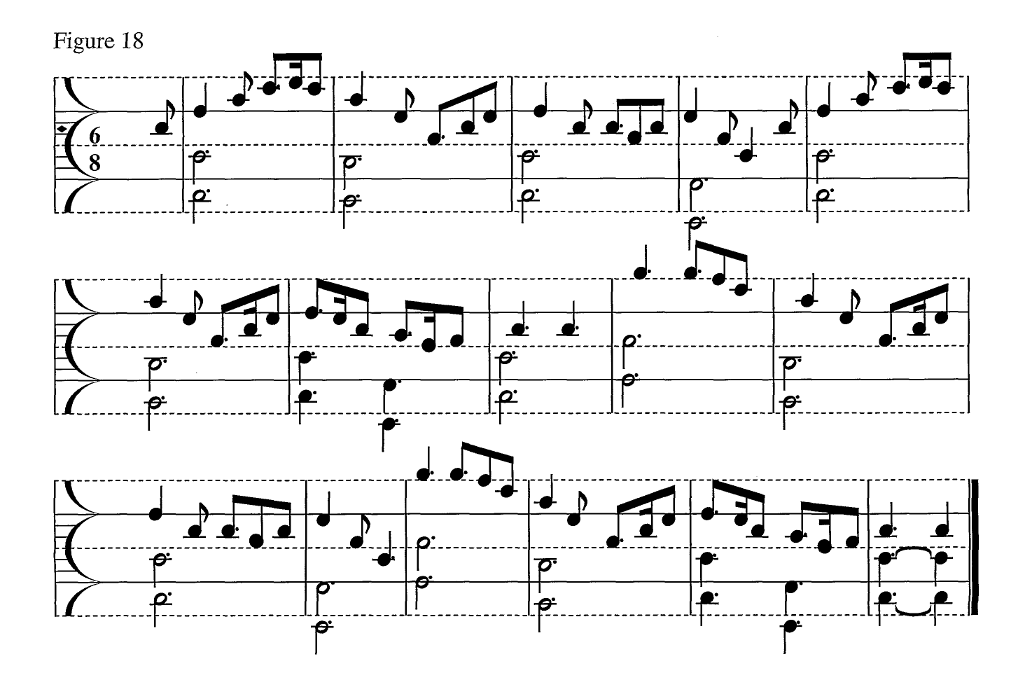

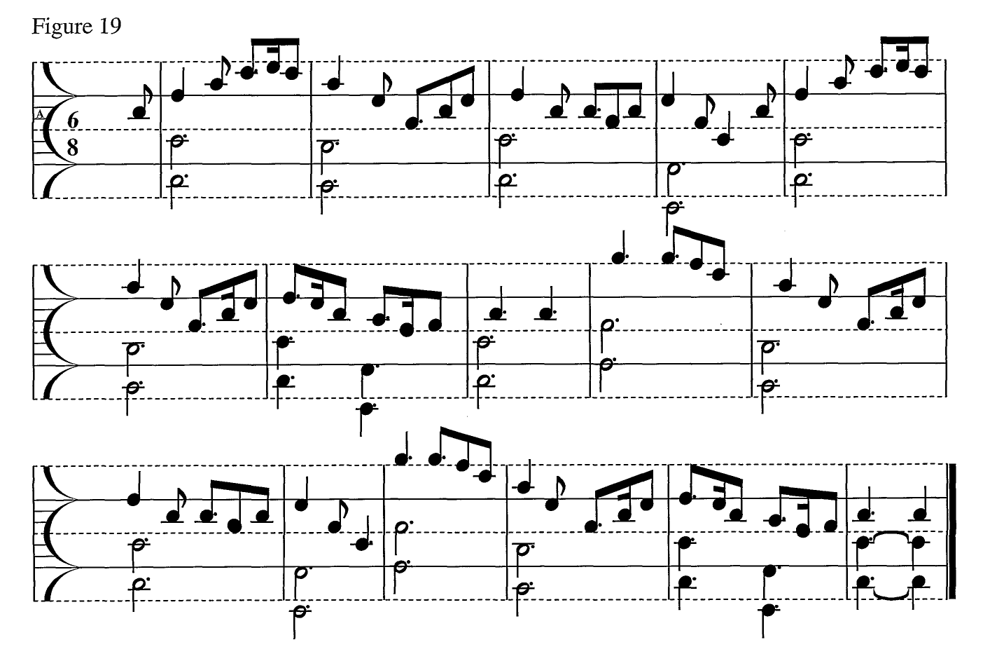

The song “Greensleeves” is shown in traditional notation in FIG. 17. The same song is shown in isomorphic solfa notation in FIG. 18, in which the tonic indicator in the La-space to the left of the clef indicates that the song is in an unspecified minor (Aeolian mode) key. In FIG. 19, the tonic indicator is the letter A, indicating that “Greensleeves” is to be played specifically in A minor.

Tonics, Modes, Major, and Minor

A brief discussion of modes, major, minor, and their relationship to the tonic is in order, to avoid potential confusion.

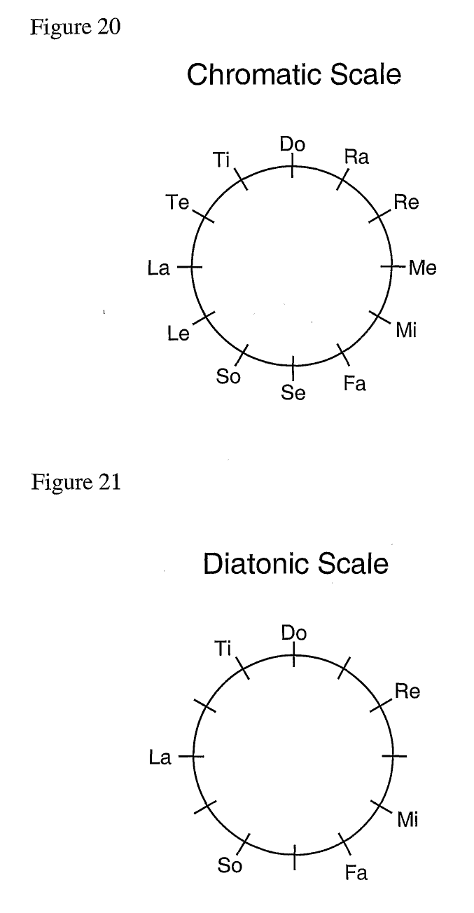

FIG. 20 shows a circle divided by twelve lines around its perimeter, just as a clock face is divided to indicate the twelve hours of the day. In this figure, the twelve divisions correspond to the division of the octave into the twelve chromatic intervals, which are labelled with their solfa names. Each successive solfa name, going clockwise around the circle, indicates an interval that is one semi-tone wider than that indicated by the previous name—just as each successive hour-digit on a clock face indicates a time that is one hour later than the previous digit. “Do”, at the top, indicates both unison and its octave, just as the “12” on a standard clock face indicates both midnight (00:00 o'clock) and noon (12:00 o'clock).

FIG. 21 shows the same clock face—however, only the labels of the notes that define the diatonic scale are shown. Some of the intervals between notes are two semi-tones (a whole tone) wide—Do-Re, Re-Mi, Fa-So, So-La, and La-Ti—whereas some are only one semi-tone wide—Mi-Fa and Ti-Do. The particular pattern of wider and narrower inter-note intervals shown in FIG. 21 is the defining characteristic of the diatonic scale.

Different scales—harmonic minor, pentatonic, hexatonic, whole tone, etc—include or exclude a different subset of the chromatic notes, thus producing a different circular pattern of intervals between included notes.

The “modes” of the diatonic scale always have the diatonic scale's circular sequence of intervals. The only difference between the modes is the note on which the mode starts its journey around the scale's circle of intervals. The starting—and therefore ending—note of a mode in this circular journey is the tonic of that mode.

The modes of the diatonic scale can be summarized as follows:

| | | |
|---|---|---|
| Do | Ionian | w-w-s-w-w-w-s |
| Re | Dorian | w-s-w-w-w-s-w |
| Mi | Phrygian | s-w-w-w-s-w-w |
| Fa | Lydian | w-w-w-s-w-w-s |
| So | Mixolydian | w-w-s-w-w-s-w |
| La | Aeolian | w-s-w-w-s-w-w |
| Ti | Locrian | s-w-w-s-w-w-w |

In the discussion of the present invention, the phrase “major key” always means “Ionian mode”, and the phrase “minor key” always means “Aeolian mode”. Other modes—Dorian, Phrygian, and Locrian—are sometimes called “minor” modes because the interval from their root to their third is minor. This “simplification” actually confuses the issue by treating different modes as being the same, when they are not.

In isomorphic solfa notation, the tonic indicator is placed on the tonic of the given song's scale's mode. Therefore, if a song is written in the diatonic scale's Ionian mode, its tonic will be placed on Do. If the song is written in the diatonic scale's Aeolian mode—the natural minor of Ionian mode—its tonic indicator will be placed on La.

When teaching music using isomorphic solfa notation, the various Greek names for the modes should be ignored in favour of the much more mnemonic Do-mode, Re-mode, Mi-mode, etc. This approach to explaining modes and the “major-minor” distinction makes teaching, learning, and playing chords much easier. (The Greek names can always be memorized after the theory is understood.) Building a tertian chord rooted on Re, for example, is a simple matter of selecting notes from the odd-numbered degrees of Re-mode. This is just another example of how isomorphic solfa makes music theory easier to learn, by exposing rather than hiding the consistent fundamentals of music theory.

Thus it can be seen that to notate tonal music in any embodiment of the present invention's musical staff, two unique locations must be specified: the location of Do and of the tonic. In the preferred embodiment, the location of Do is indicated uniquely and consistently by the tips of the crescent-shaped clef symbol; while the current location of the tonic, which can vary over the course of a given piece, is indicated with a tonic indicator.

The present invention would benefit from a means of indicating key and mode changes within a given piece. Many such means are possible within the scope of the present invention, but no preferred means for indicating such key or mode changes is specified herein.

Octave Indicators

Unlike acoustic musical instruments, individual electronic instruments can have nearly infinite range potentially producing—from a single instrument—both lower pitches and higher pitches than the human ear can detect, and every pitch in between. Therefore it is particularly beneficial for electronic instruments to use a notation that is consistent in all octaves. This consistency requires a means of indicating—when it matters—what specific octave is most appropriate for a given part or piece.

In traditional notation, each line or space in the Grand Staff denotes a specific pitch, so no other indication of octave is necessary. The symbols “8va” or “15va” are sometimes used as a notational convenience, indicating that the thus-indicated notes should be offset an octave or two higher or lower than indicated by the staff. These offset symbols can be used within the present inventions as well, with the same meaning. Nota Graph, although isomorphic, still notates specific pitches, and uses different clefs to indicate the octaves of the notes to be played.

Isomorphic solfa notation notates intervals, which are independent of pitch and therefore of octave as well. The use of tonic indicators to associate vertical locations with pitch classes was discussed above. To fully specify the pitch associated with each isomorphic solfa interval, one needs to be able to indicate octave too.

There is no international standard for denoting the octave of a given pitch outside of the context of a musical staff—or rather, there are many competing standards, none of which is dominant. The Musical Instrument Data Interface (MIDI) standard defines Middle C (note 60) as “C5”, with the “5” indicating that it is five octaves above the lowest C that MIDI supports—C0 (note 0). In the MIDI standard, C is also the starting note in each octave, so B0 (note 11) is followed by C1 (note 12). Other organizations use different octave-numbering conventions. In the preferred embodiment of the present invention, isomorphic solfa notation will use the MIDI standard's octave-numbering convention, although alternative numbering conventions are also envisioned.

FIG. 22 shows one embodiment of such an octave indicator, in which a numeral is placed immediately to the right of the tonic indicator on an isomorphic solfa staff. If the tonic indicator is not present, then the octave indicator can act as a tonic indicator. The octave indicating numeral indicates the octave of the tonic in accordance with the MIDI specification.

In FIG. 22, the octave-indicating numeral “5”, placed as it is on the Do-line, indicates that the song is to be played in an unspecified major key in the fifth octave. C5 (middle C, MIDI note 60) would be a valid interpretation, as would B5 (MIDI note 71)—eleven semi-tones higher than C5—and every note in between.

In FIG. 23, a specific pitch—both note-name C and octave 5—is indicated for the song “Amazing Grace”, completely specifying that the tonic pitch (Do) is middle C. FIG. 22 and FIG. 23 are both identical to FIG. 14, except for the octave indicators.

It is often useful to notate music on multiple staves, for different hands, voices, or instruments. It may be useful to indicate the relative octave in this case, rather than the absolute octave. For example, it might be useful to indicate that the left-hand part should be played one octave below the right-hand part; whatever octave the musician chooses for the right-hand, the left will be one octave lower. In one embodiment, a plus (“+”) or minus (“−”) sign followed by a numeral, used as a tonic indicator, tells the musician the offset between one staff and another, as shown in FIG. 24. As a convention, the highest-pitched staff (or set of staves) should act as a reference point, with the lower-pitched octaves indicating their relative offsets as necessary. By default, each successively lower staff is presumed to indicate pitches one octave lower than the staff immediately above it, unless otherwise specified.

In another embodiment, relative offsets would be enclosed in parenthesis (eg, “(−1)”), to distinguish them from octaves less than zero. (One might wish to indicate that notes should be played in octaves that were below the range of human hearing, because while their fundamentals would not be heard, their overtones could be.)

Scale Indicators

One impediment with any chromatic staff (such as Nota Graph or the isomorphic solfa staff) is that the vertical locations associated with any given scale therein—diatonic, harmonic minor, whole tone, pentatonic, etc—can be lost amid the “unused” chromatic locations. This impediment can be partially addressed through the use of scale indicators.

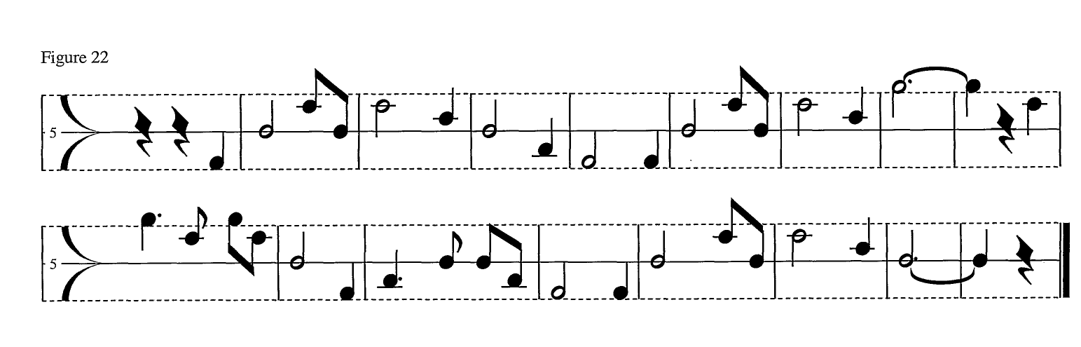

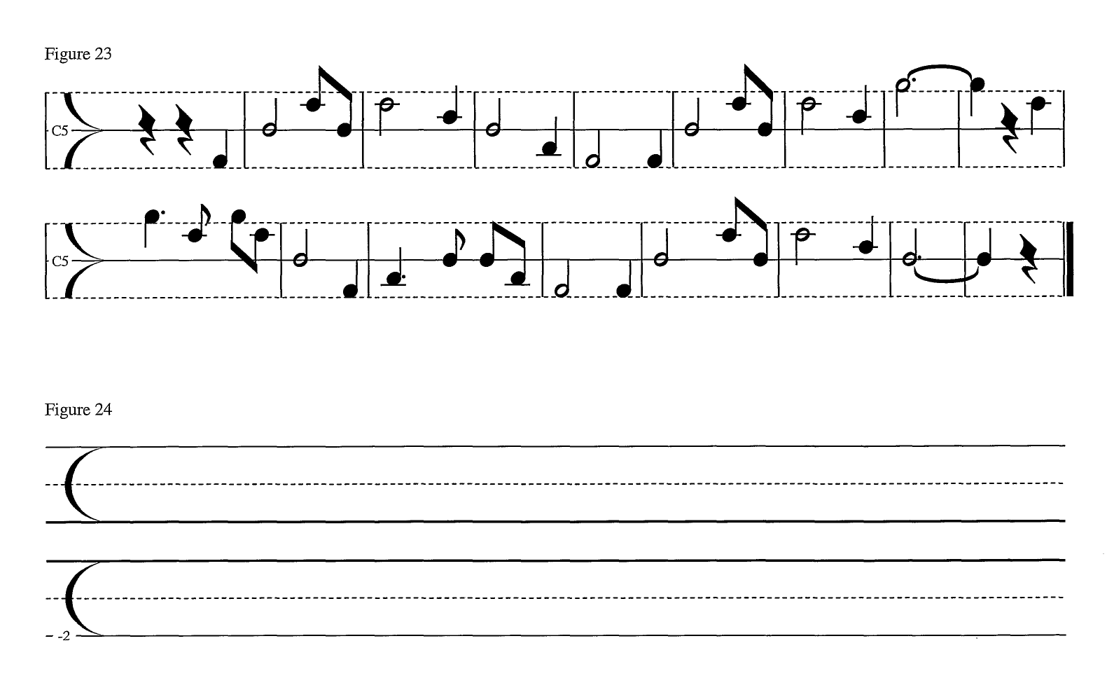

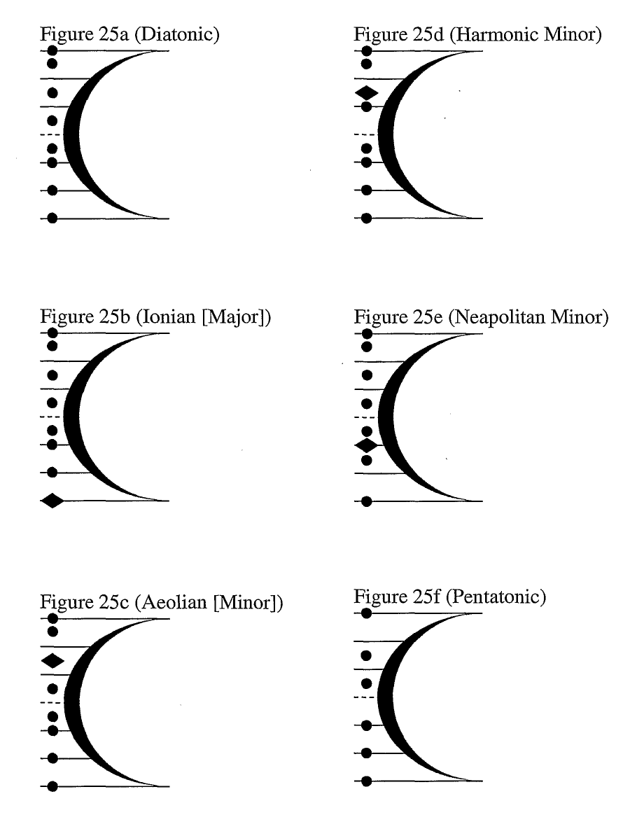

One embodiment of scale indicators is shown in FIG. 25a. Each note in the diatonic scale is indicated with a small round dot vertically centred in the vertical location associated with that note. The preferred embodiment of the scale indicator is a disk with a diameter between one-third and one-half of the width of the gap between adjacent lines in the isomorphic solfa staff. This proportion ensures that there is a small gap between dots on adjacent vertical locations.

The scale dots and tonic indicator in FIG. 25b indicate a Do-mode diatonic scale.

The scale dots and tonic indicator in FIG. 25c indicate a La-mode diatonic scale.

The scale dots and tonic indicator in FIG. 25d indicate the La-mode of the Harmonic Minor Scale (HMS). To form the HMS, the diatonic scale's La-mode's seventh degree is raised one semi-tone, from So to Le.

The scale dots and tonic indicator in FIG. 25e indicate the Neapolitan minor scale. The Neapolitan minor is a diatonic Mi-mode (Phrygian) scale with its seventh (Re) raised a semi-tone to Me. The Neapolitan Minor Scale is to the diatonic Mi-mode what the HMS is to the diatonic La-mode: a diatonic mode with its seventh raised one semi-tone. FIG. 25f shows the Pentatonic scale.

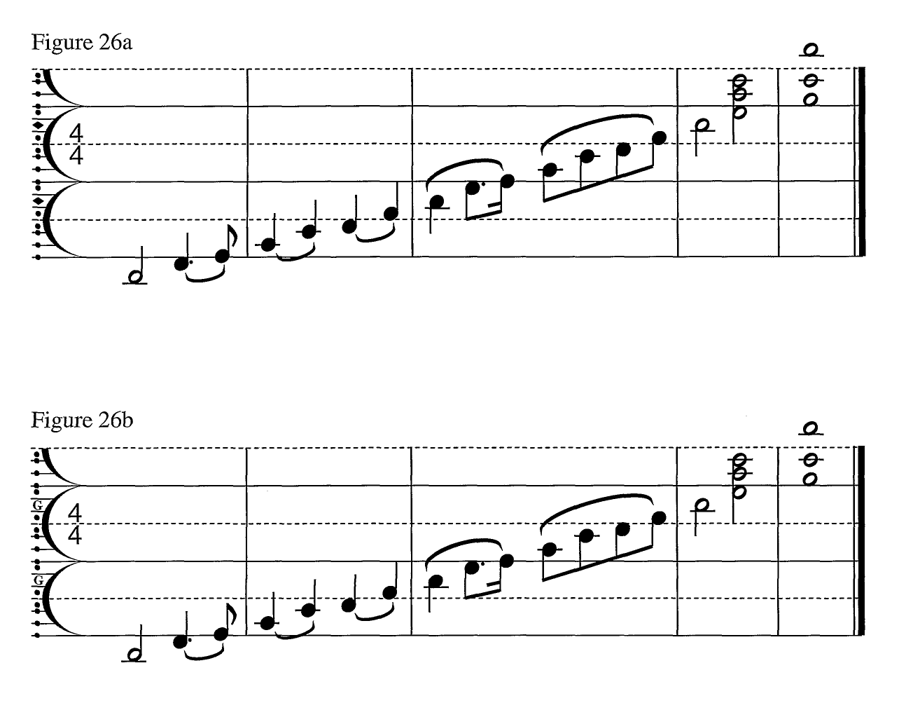

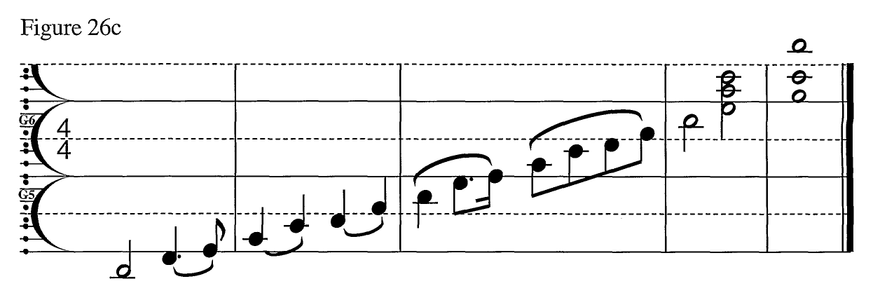

FIG. 26a shows a minor scale, in rhythm, notated on two and a half stacked isomorphic solfa staves. This example is drawn from the second task of the MNMA's Notation Test, as documented in its Music Notation News, Vol 10, No 2, 2^{nd} Q 2000, page 6. The Notation Test requires the transcription of the G-Minor scale to the proposed system. This transcription generalizes the result by placing a tonic-indicating diamond in the La-space.

The G minor scale could be specified uniquely, by placing (in the La-space of the same staff that includes the time signature) the note-name G instead of a diamond, as shown in FIG. 26b.

The octave could be specified by placing (in this case) the numeral 5 after the G, indicating that that particular instance of the La-space should indicate the specific pitch G5 (note 55), as shown in FIG. 26c.

An experienced musician can derive the scale and tonic of any given song by scanning its chords and/or melody. The use of scale indicators makes this same knowledge available to less-experienced musicians, in a compact, easily-accessible, and general-purpose form.

The use of scale and tonic indicators is entirely optional in isomorphic solfa notation. They are a useful aide to learning and playing unfamiliar music.

Isomorphic Solfa Sequencer Notation

While the isomorphic solfa staff described above is analogous to the traditional five-lined staff, there is another kind of musical staff in wide use today: the sequencer staff, also known as “piano roll” staff. In the sequencer staff, notes are not placed on staff lines, but occur only between the lines, on note spaces. Further, the notes are indicated in these spaces by bars, the starting and ending points of which, along a consistent time scale, indicate the points at which the note is begun and stopped respectively.

In traditional sequencer notation, note spaces correspond to pitches. In the present invention, the note spaces of isomorphic solfa sequencer notation correspond to intervals, with an optional clef symbol indicating the locations of Do and its tritone, optional scale dots, tonic indicators, etc.

Benefits

The isomorphic solfa notation system discussed above provides advantages to the student musician as the eye hand coordination found in “sight-reading” players of traditional pitch based instruments can be reproduced with isomorphic solfa notation as it provides correspondence between intervals rather than pitches.

Therefore a musician using the isomorphic solfa system can do something that traditional pitch-based musicians cannot: read intervals right off the page, and use them as an additional guide to learning and playing. The intervals between notes are, in isomorphic solfa, as meaningful as the notes themselves.

Further, the student, learning with isomorphic solfa notation on an isomorphic instrument, need not memorize facts, fingerings, chord progressions, etc, for all twelve keys. These things only need to be learned once, in solfa, and can then be applied to all keys.

Also, the exposure of the underlying patterns of intervals in isomorphic notation reveals the fundamental order and logic underlying music theory, facilitating deep understanding, such that the facts can be derived as needed rather than memorized by rote.

This reduction in the number of facts to be memorized, stemming from the exposure of intervals via isomorphic solfa, can be demonstrated in the naming of chords, discussed below.

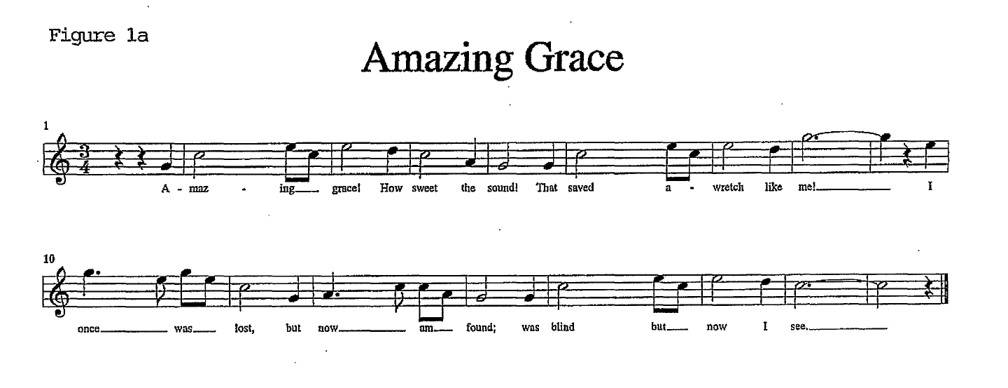

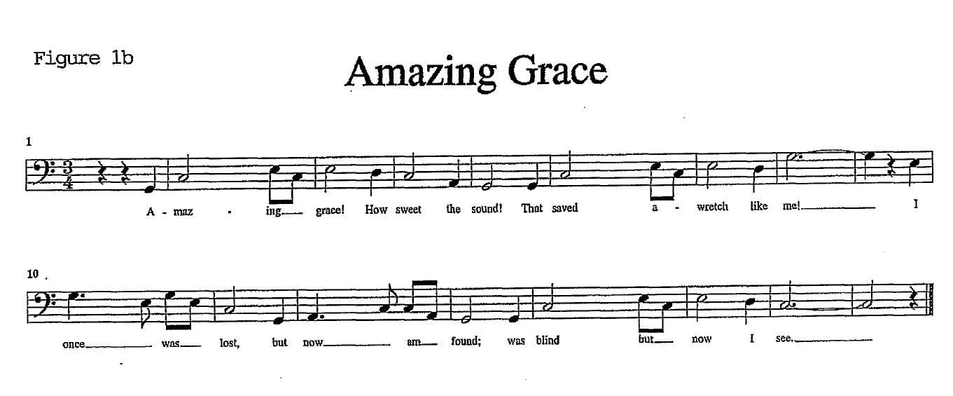

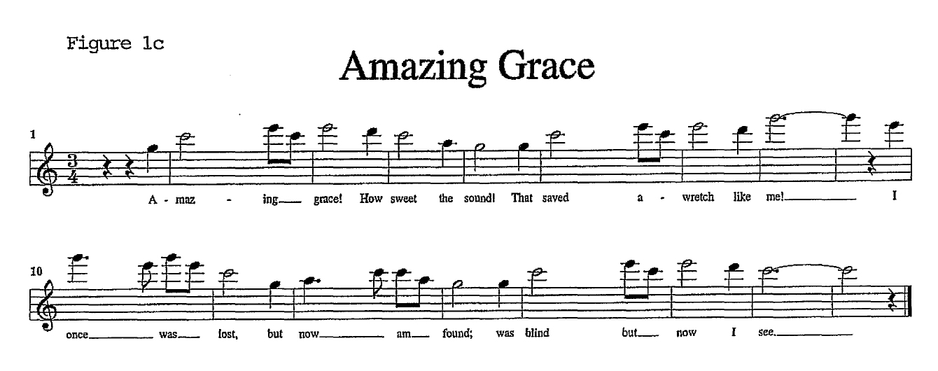

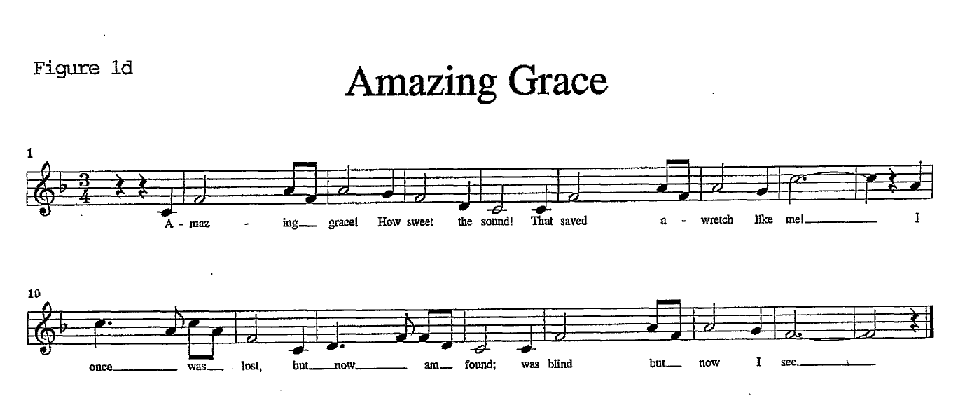

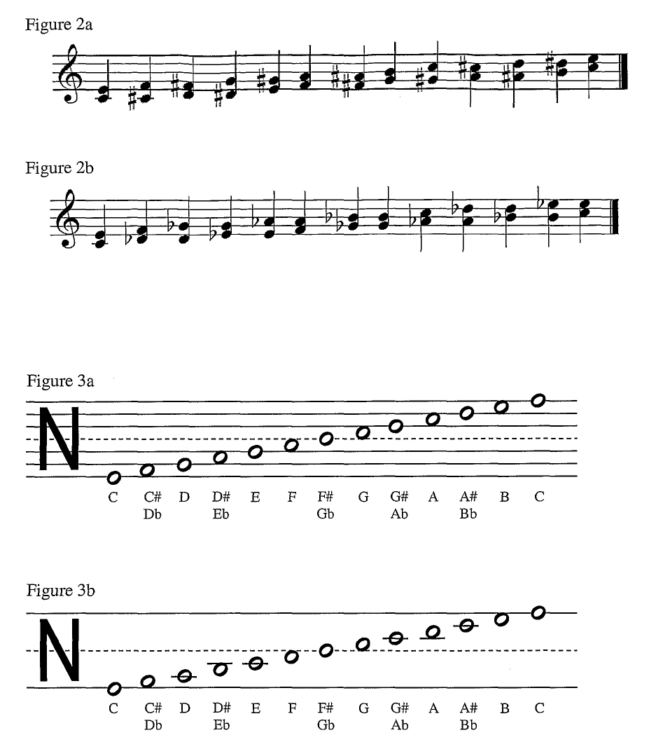

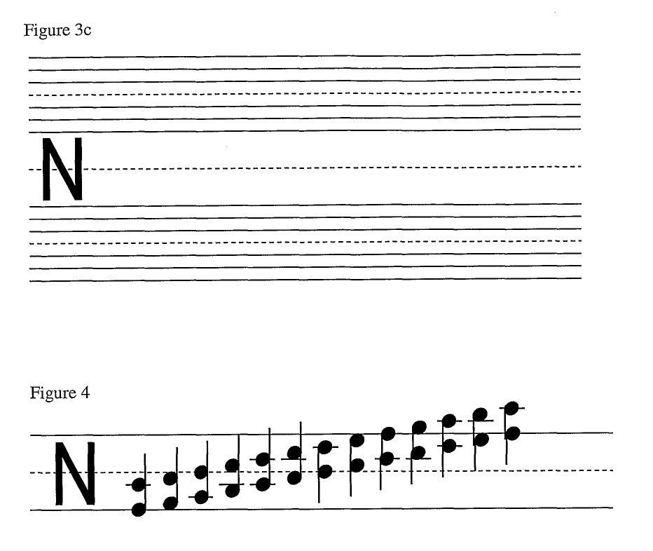

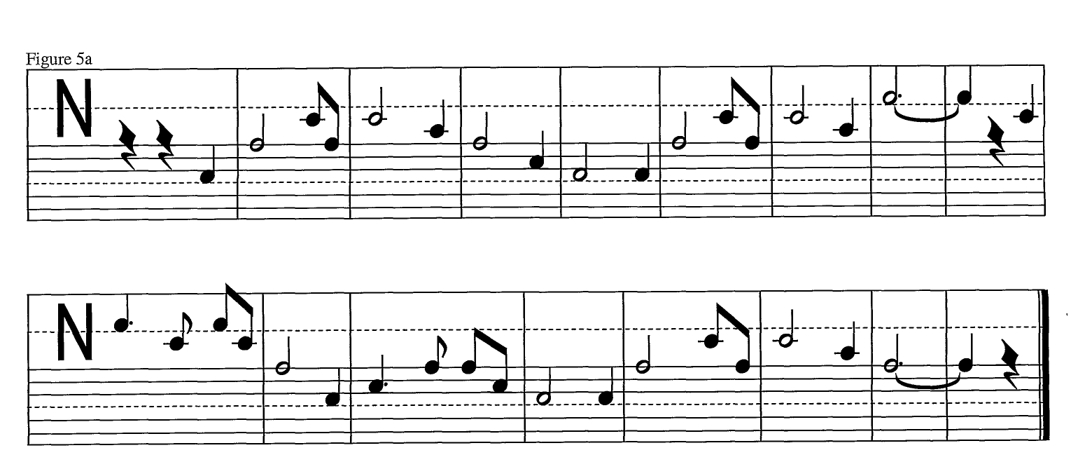

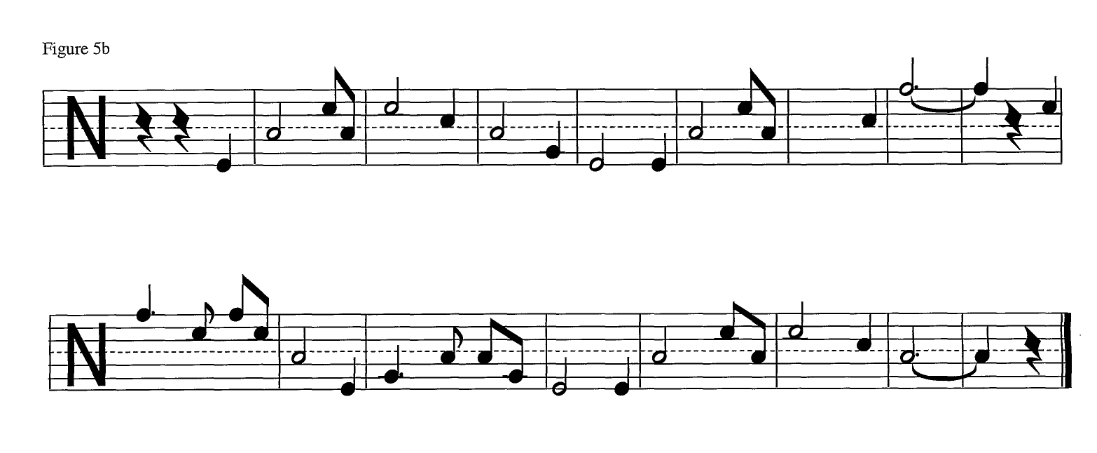

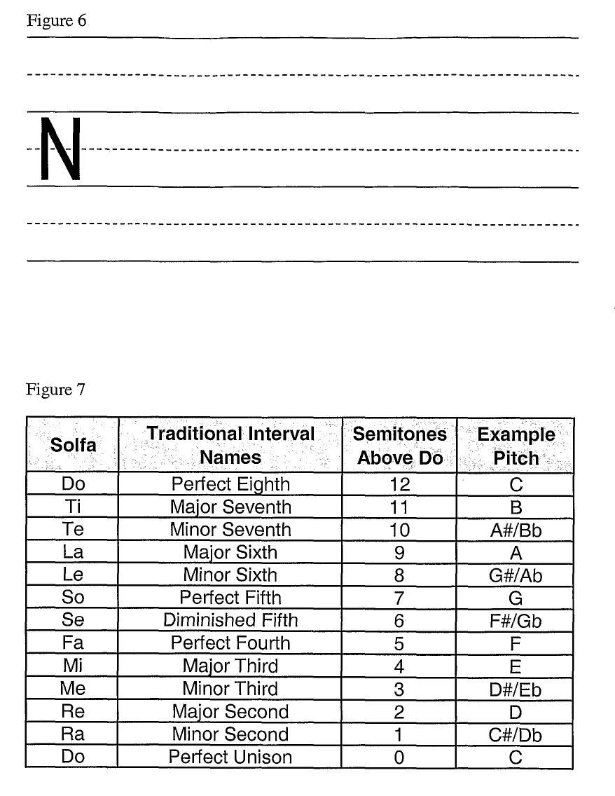

The isomorphic solfa notation system described above can be used to represent musical sequences for use by musicians. It is possible to transcribe existing music from traditional and alternative notations forms into isomorphic solfa notation by transcribing each note from the previous notation into isomorphic solfa notation. Examples of this transcription are provided in FIGS. 1 and 12. The transcriber may start with a musical sequence in traditional notation and would determine where the note should be placed on the isomorphic solfa staff and would progress through each note in the same manner to transcribe the complete musical sequence. Alternatively, the transcriber may start with an aural version of the musical sequence and could then notate what is heard using the isomorphic solfa staff. Transcription may be done electronically using this method. The isomorphic solfa staff could also be used to notate original musical sequences.

A musical sequence and/or combination is represented using the music notation system described above and can then be presented on paper. Furthermore, the music notation system can be used to represent a musical sequence and/or combination in electronic form, for example on a computer screen. A musical sequence and/or combination can also be stored electronically and then viewed, printed or edited.

Isomorphic Solfa Chord Symbols

In the preferred embodiment, each interval symbol is chosen to be more or less mnemonic for either (a) the geometric shape of said diatonic interval on a given isomorphic keyboard (as described below), or (b) the number of (equally-tempered) diatonic minor seconds in said interval. In the preferred embodiment, based on the Wicki/Hayden isomorphic keyboard, the interval of one minor second is assigned the symbol “.”; two minor seconds (the major second), “:”; the minor third, “\”; the major third, “−”; and the perfect fourth, “|”. Additional symbols can be defined for larger intervals within the scope of this invention.

A major triad on any root named “Xx” would be indicated with the symbol string “Xx-\”, in which Xx named the root note, “−” indicated that the next note was a major third higher than the previous, and “\” indicated that the next note was a minor third higher than the previous. Examples would include Bb-\ and Do-\. Similar strings can be constructed for all other diatonic tertian chords, added-sixth chords, and sus2 and sus4 chords. Inversions can be indicated by prefixing the root with the number of the chord note that is in the bass (eg, 3Xx-\ for “first inversion” of a major triad, 5Xx-\ for “second inversion”, and so on for extended chords).

While the preferred embodiment uses strings of common typographic symbols to indicate the stacks of intervals commonly found in chords, it may also be convenient to develop other typographic means, such as dedicated fonts or font characters, that more accurately reflect the shape of individual intervals, combine the most common symbol strings into single typographic characters, or represent specific geometric combinations of interval-patterns on a given keyboard more or less accurately.

The use of chord symbols as described above makes music easier to learn by reflecting the consistent geometry of an isomorphic keyboard in the chord symbols. By combining such chord symbols with tonic solfa, the amount of information to be learned can be reduced, and the relationships between scale degrees made obvious by geometry.

Compatibility with Traditional Instruments

It is not surprising that “inconsistency between keys” remains an unresolved problem in music notation, because it is not even recognized as being a problem. It is a direct result of the need to maintain backward-compatibility with traditional musical instruments, which, as previously discussed, are pitch-focused. The need for one-to-one correspondence between notation and fingering requires that any notation that is intended for use by traditional instruments retain the traditional focus on pitch.

The MNMA's “Directory of Music Notation Proposals” (ibid) lists Criterion #3 of its Phase I Screen as follows:
“The notation [must be] independent of all musical instruments for intelligibility, so that the notation is readily adaptable to all instruments including the human voice”.

The MNMA's rules reflect a desire to have any new notation standard be backwardly-compatible with traditional instruments. Yet the new-found popularity of guitar tablature notation—which has emerged as the dominant notation system for guitars in the last 20 years, and only works for guitar—demonstrates that a notation designed for use with a single instrument can still be remarkably useful.

Applying isomorphic solfa to traditional instruments will be addressed later in this document. First, however, to move away from this traditional focus on pitch, it is necessary to find a class of musical instruments whose fingering could be based on interval instead of pitch.

Isomorphic Keyboards

Isomorphic keyboards have two-dimensional layouts of note-controlling elements in which any two elements that together sound the same musical interval also have the same spatial interval relative to each other (edge conditions aside).

Thus, on an isomorphic keyboard, any given musical interval's fingering has the “same shape” wherever it occurs (edge conditions aside).

If each individual musical interval has a consistent fingering, then every given sequence (melody) or combination (harmony) of musical intervals has a consistent fingering, too. This means that on an isomorphic keyboard instrument, every given scale, arpeggio, melody, chord, chord progression, or any other sequence and/or combination of intervals has the same fingering in every key.

For example, having memorized the fingering pattern needed to play a particular song on an isomorphic keyboard, one need only start that same fingering pattern on a different note-controlling element to play it in any other key.

This consistency makes isomorphic keyboards dramatically easier to learn, to teach, and to play than traditional instruments. For example, on the piano keyboard, the fingering of every major scale is different—twelve different fingering patterns—whereas on an isomorphic keyboard, the fingering pattern for all twelve major scales is identical.

Janko patented two such isomorphic keyboards (German patent no. 25282 in 1883, and no. 32138 in 1885). The Chromatic Button Accordion is usually configured with one of two other such layouts, the C-System or the B-System (http://www.thecipher.com/chromatic-accordion-cipher.html).

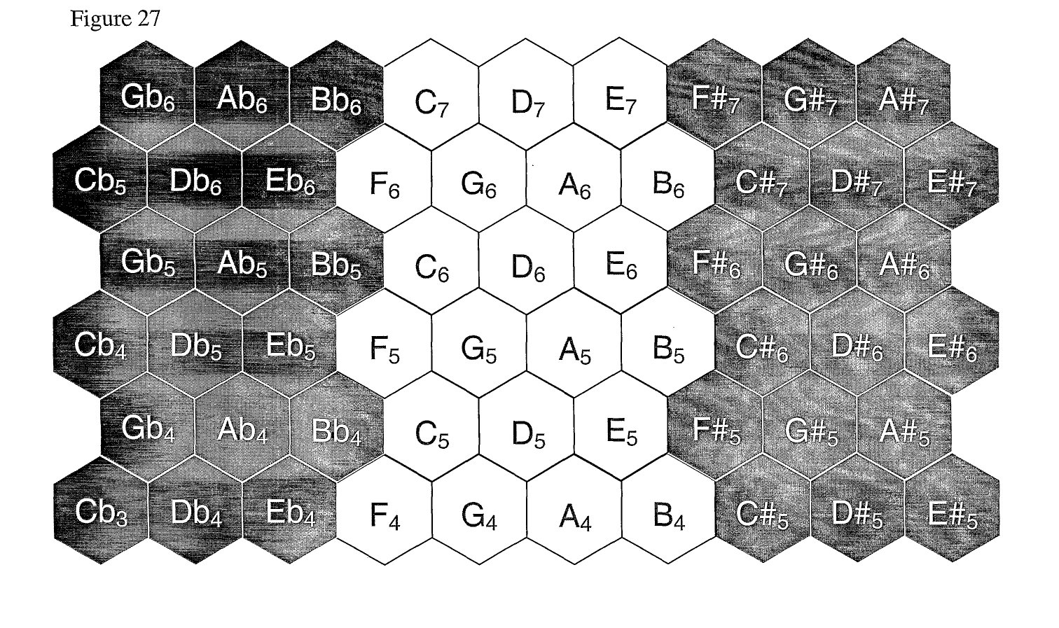

Kaspar Wicki patented an isomorphic arrangement of note-controlling devices in 1896 (Swiss patent no. 13329), which was subsequently patented by Brian Hayden in 1982 (GB Patent no. 2131592). The Wicki/Hayden keyboard, labelled with pitches, is shown in FIG. 27.

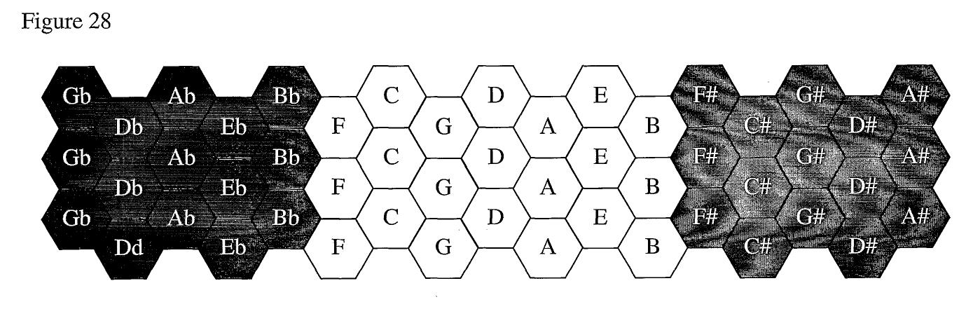

Wesley patented a variation on the Wicki/Hayden layout twenty years later in 2002 (U.S. Pat. No. 6,501,011). The Wesley layout is shown in FIG. 28.

Isomorphic Keyboards and Notation

Isomorphic keyboards are a perfect match with isomorphic staff notation such as Nota Graph. In isomorphic notation, the pattern of intervals does not change when transposing a song from key to key—the same pattern of intervals just moves to a new position on the staff, the same way the isomorphic keyboard player's hand moves to start the same fingering pattern on a different button.

However, there is still an impediment. To transpose a song to another key, one must move notes on the staff and one's hand on the keyboard. Even with an isomorphic keyboard and notation, this impediment—“inconsistency between keys”—remains.

Electronic Transposition

It was considered that electronic transposition would offer a solution to this dilemma. One would simply transpose the keyboard into the desired key, such that the pitches under the white keys were those of the selected major scale. Using such electronic transposition on an isomorphic keyboard would make it unnecessary to move one's hand to a new set of notes to transpose—the new set of notes would be moved underneath one's hand electronically, instead.

This has previously been proposed and rejected. Robert Gaskins, a noted expert on duet concertinas, has written an exhaustive analysis comparing and contrasting the use of an isomorphic keyboard (the Hayden system) and a comparable non-isomorphic keyboard (Maccann). He concluded that:
“ . . . [hypothetically adding transposing] electronics has just removed most of that advantage of the Hayden system, not perfected it . . . an electronic concertina would perfect the great advantage of the Hayden system to “play in any key with the same fingering”, but at the same time would confer that same advantage on the Maccann system”.

This conclusion—that electronic transposition eliminates the “easy transposing” advantage of isomorphism, by making all keyboards easily transposable—defines standard practice. However, this line of reasoning completely overlooks the intrinsic value of isomorphism—its consistent exposure of intervals—from which “easy transposition” arises as a mere side-effect.

If easy transposition were the only requirement, the electronically-transposable piano keyboard, combined with “fake books” in which each song is written in C (or its relative minor), would provide a solution. (The commercial availability of such transposition-based fake books is a recent development.) That combination allows the keyboardist to read traditional notation written in C, playing only the keyboard's white keys (except for accidentals), after transposing the electronic keyboard into whatever key is desired for whatever reason.

This “solution” combines a non-isomorphic keyboard with a non-isomorphic notation. Pitch is still the centre of attention—it is just that the notated pitches are not the ones being produced by the keyboard. This abuses the meaning of pitch-names in both the notation and the instrument, without delivering the fundamental benefits of isomorphism. To get the true benefits of isomorphism, the focus of both notation and instruments must be on intervals, not pitch.

Isomorphic Solfa Keyboards

An instrument suitable for teaching a student to play a musical sequence and/or combination notated according to the above defined notation system is also included within the scope of this invention. Particularly, an isomorphic keyboard is described which includes tonic solfa names on its buttons. Alternatively, the buttons may be labeled with symbols, colours, numerals, or other means by which the student develops an association between (a) the keyboard's buttons and (b) musical intervals rather than pitches. Further, the buttons may be left entirely blank, or colored only according to the piano's traditional two-colored diatonic-chromatic categorization, but still included under this invention if study of any associated, referenced, or implied instructional material can reasonably be expected to develop, in the student's mind, an intimate association between specific buttons and specific intervals rather than specific pitches. In the following discussion, it will be assumed that the instrument's buttons are labeled with tonic solfa names, without limitation.

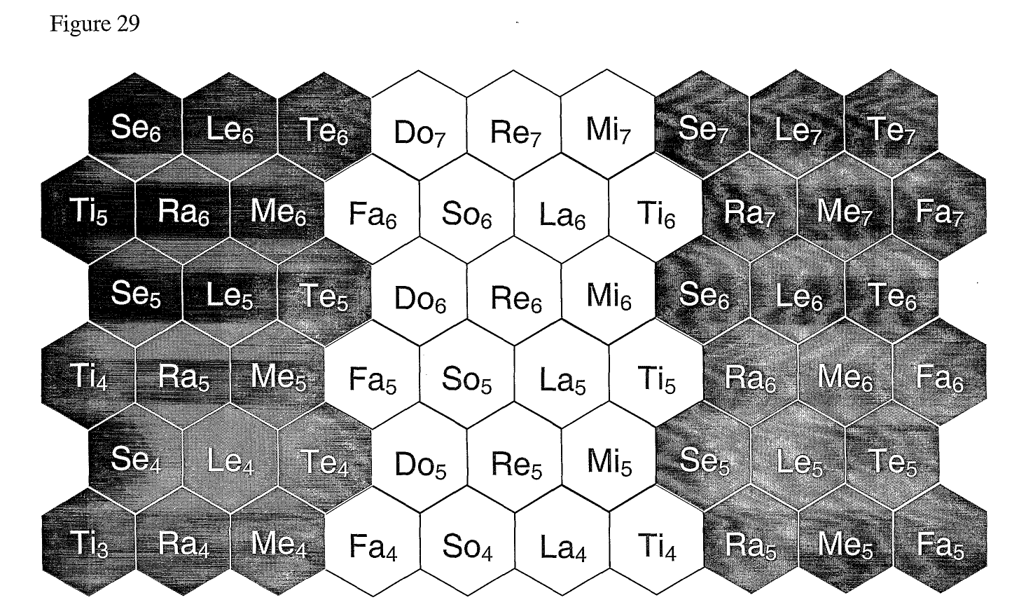

FIG. 29 shows an embodiment of a Wicki/Hayden keyboard with solfa-labelled buttons. The keyboard arrangements in FIGS. 27 and 29 will sound the same pitches, if the button labelled “Do5” in FIG. 29 is associated with the pitch C5 (MIDI note 60).

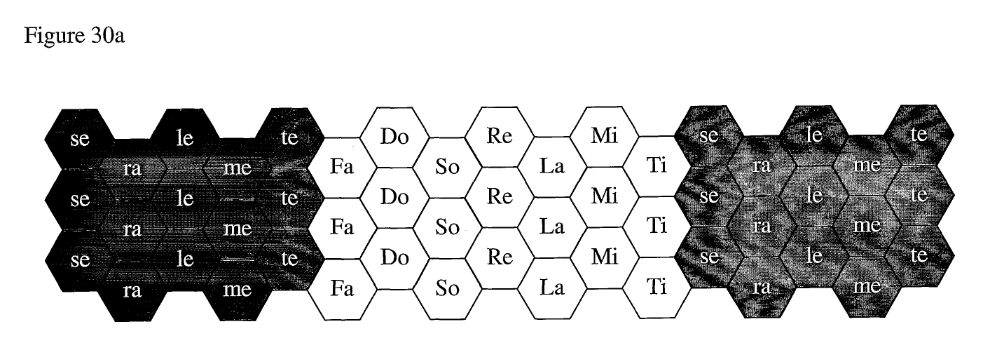

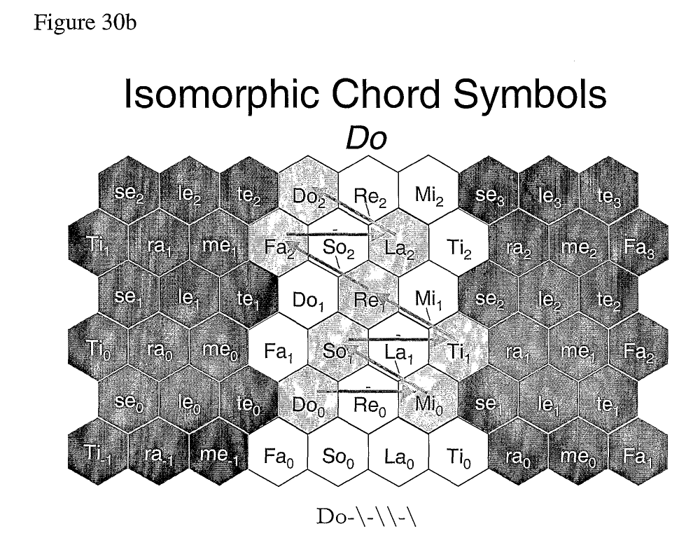

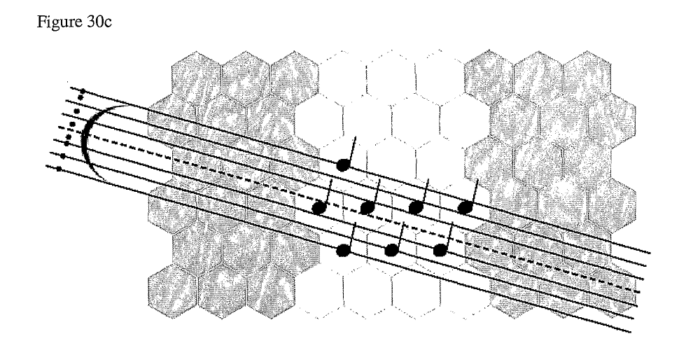

FIG. 30a shows an embodiment of a Wesley keyboard labelled similarly. (Its octaves are unlabeled, but increase from bottom to top as with the Wicki/Hayden arrangement.) Any isomorphic keyboard can have a similarly solfa-labelled embodiment.

Electronic transposition can be used to associate specific pitches with the solfa intervals. Many user interfaces are possible for specifying this association. Their discussion is beyond the scope of the present invention.

Associating solfa names with the buttons of an isomorphic keyboard focuses its player on intervals rather than pitches. Each simple interval has a unique solfa name, with no accidentals, key signatures, or pitch names to confuse matters. (In some embodiments, both enharmonic names can be used, with the “sharp” names on the higher-note side of the diatonic notes and the “flat” names on the lower-note side, but only the flat names are used in the preferred embodiment.)

More importantly, the combination of electronic transposition, solfa, and isomorphic keyboards facilitates for use of the isomorphic solfa music notation system discussed above.

As previously described, FIG. 29 shows an isomorphic Wicki/Hayden keyboard with its buttons labelled with solfa names, whereas FIG. 30a shows a Wesley keyboard similarly labelled.

There is a one-to-one correspondence between isomorphic solfa notation and the buttons of an isomorphic solfa keyboard such as those shown in FIGS. 29 and 30a. Having transposed such a keyboard into the key and octave indicated (or chosen by the conductor or musician), each unique vertical location of the isomorphic solfa staff indicates a specific button on the isomorphic solfa keyboard (although enharmonic note-controlling buttons may be present). This gives musicians the opportunity to develop the same eye-hand coordination found in “sight-reading” players of traditional pitch-based instruments—except that with the isomorphic solfa keyboard and isomorphic solfa notation, the correspondence is between intervals, not pitches.

The isomorphic keyboard and staff are both geometric systems for arranging the 12 tones of the chromatic scale. It is therefore reasonable to expect that each has a geometric relationship to the other—and they do.

FIG. 30c shows the relationship between the keyboard and staff. The buttons in rows that include Do all fall on staff lines; the buttons in rows that do not include Do all fall on staff spaces.

The diatonic scale is reflected in the pattern of white buttons on the keyboard, and in the pattern of scale dots stacked to the left of the staff's clef sign. A reversal of this color pattern, or an assignment of unique colors to each diatonic or chromatic note, would be alternative embodiments of the present invention.

The staff crosses the keyboard at an angle of about 16°.

Although not shown, it is easy to imagine the mirror-image of an isomorphic keyboard such as that shown in FIG. 27, in which the pitch of minor seconds increases from right-to-left instead of left-to right as shown in FIG. 27. One can further imagine that the version shown in FIG. 27 would be associated with one of the player's hands, and that its mirror-image would be associated with the player's other hand. Since a person's hands are mirror-images of each other, providing such mirrored keyboards can provide consistent fingering to each hand.

In the preferred embodiment of the present invention, any labels, symbols, or other indicia associated with the buttons of such a keyboard should be mirrored, too.

Functional Harmony

Harmony is functional as well as structural. In both major and minor keys, the tonic chord is a chord of rest; the dominant is a chord of tension. In major keys, the tonic is always Do, and the dominant is always So. In minor keys, the tonic is always La, and the dominant is always Mi. Thus the solfa names of the chords' roots, combined with the tonic indicator and scale dots, tell the musician something meaningful about their role in functional harmony. For functional analysis, traditional notation requires the use of a separate notation—using Roman numerals for each degree of the scale—because pitch-names tell a musician nothing about their function in a given piece of music. Isomorphic solfa names do.

FIG. 30b shows a three-octave isomorphic solfa Wicki/Hayden keyboard in which the diatonic scale's tertian sequence is extended from the lowest occurrence of Do upwards for two octaves. This tertian sequence—the “Circle of Thirds”—is the same for all modes of the diatonic scale, and shows the order of major and minor thirds in all of the diatonic tertian chords.

Within the diatonic scale, one is rarely, if ever, going to play a dominant 7 (−\\) or half-diminished (\\−) chord on Do—such a chord is contrary to Do's diatonic tertian sequence, which starts with a major 7 chord (−\−). On the other hand, playing a dominant 7 chord on So or a half-diminished 7 chord on Ti would fit the diatonic tertian sequence perfectly, and as such is entirely expected.

On the other hand, despite the fact that the diatonic tertian chord on Re is a minor 7 (\−\), one might very well play a dominant 7 chord on Re, because Re is a common “secondary dominant” (V/V, or “dominant of the dominant”). The appearance of a dominant 7 chord on Re, which includes a chromatic note (unlike Re's diatonic tertian chord), indicates to the attentive musician that something “interesting”—ie, not strictly diatonic—is happening in the music.

Although the above examples are based on the diatonic scale, similar examples can be drawn from the Harmonic Minor Scale, Jazz Minor Scale, Neapolitan Minor Scale, or any other 12-ET scale.

Because isomorphic solfa keyboards, notation, and chord names work together to expose music's patterns of intervals—thereby exposing both their structure and their function—isomorphic solfa makes music easier to teach, learn, and play.

Isomorphic Solfa-Based Harmonic Lattice

Consider FIG. 31, which shows the diatonic portion of a “harmonic lattice” built atop a Wicki/Hayden-layout isomorphic keyboard. The harmonic lattice was invented by Leonhard Euler around 1730, but the orientation of its axes to match a given isomorphic keyboard and its use of tonic solfa are features of the present invention. In a harmonic lattice, parallel lines of perfect fifths are separated by major and minor thirds. Each triangle thus enclosed by a minor third, a major third, and a perfect fifth represents a major or minor triad, while a contiguous pair of minor thirds indicates a diminished triad and a contiguous pair of major thirds indicates and augmented triad.

Traditionally, harmonic lattices have been drawn with the axes of perfect fifths and major thirds substantially perpendicular to each other (and with the axis of perfect fifths usually substantially horizontal). The orientation shown in FIG. 31 is thus contrary to standard practice. This orientation is beneficial, however, since it corresponds with the geometry of the isomorphic keyboard. Other embodiments, altered and/or mirrored to correspond with the geometry of other isomorphic keyboards, labelled with pitches or intervals, are considered to be within the scope of the present invention.

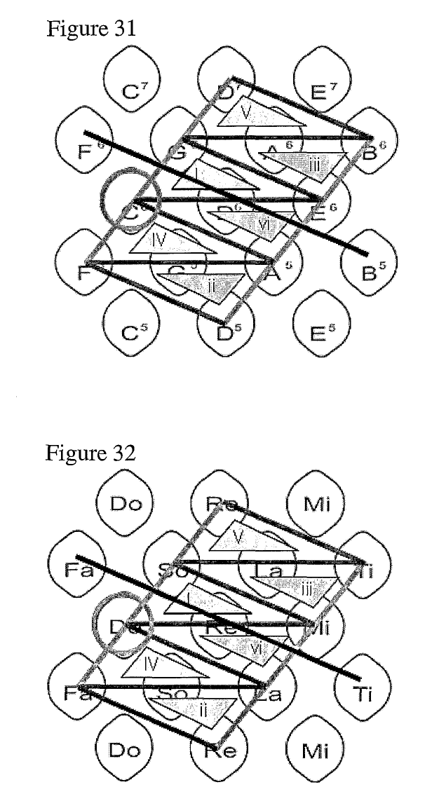

As can be seen in FIG. 32, all of the triads of the diatonic scale can be represented on a solfa-based harmonic lattice that is the same for all keys.

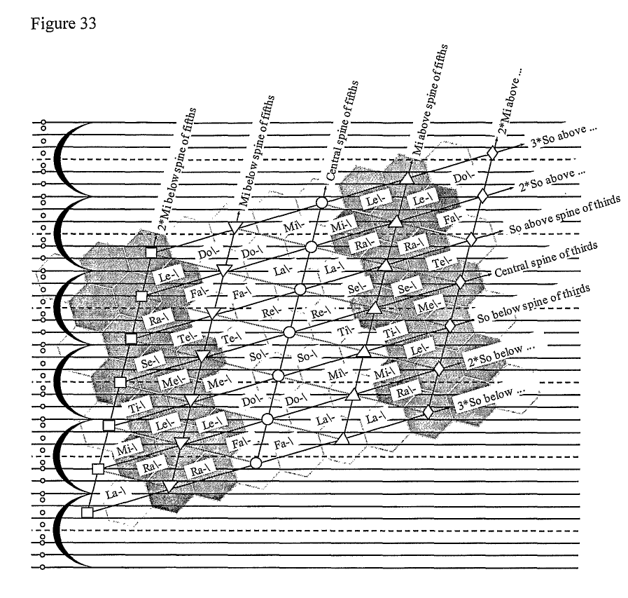

FIG. 33 shows an isomorphic solfa staff, keyboard, and lattice, with each enclosed triangle labelled with its chord symbol. Thus the geometric relationships among the isomorphic solfa system's keyboard, staff, chord symbols, and lattice are shown in a single image.

In the isomorphic solfa system, the patterns of intervals that form the foundations of Western music are inter-related and consistently displayed, making music easier to visualise, teach, learn, and play.

Isomorphic Solfege for Acoustic Instruments

The above discussion illustrates the advantages of combining isomorphism and tonic solfa (“moveable Do”) for electronically-transposable musical instruments. This section will discuss the advantages of combining isomorphism and solfege (“fixed Do”) for traditional musical instruments.

For historical reasons, many band and orchestral instruments use music that is written in a different key than is sounded by the instrument when played. These are called “transposing instruments”. The key of each instrument is identified by the note it sounds when a C is notated in its music.

The Bb clarinet is one example. When a Bb clarinet plays the note indicated as C in its music, the sound that emerges is actually a Bb in concert tuning—two semi-tones lower than notated. Alternatively put, to play a concert C, the Bb clarinettist's music must notate a D, two semi-tones higher. This example exposes the naming convention for transposing instruments: the instrument's “native” key is defined to be the note sounded, in concert pitch, when a C notated in the transposing instrument's music is played—hence the name “Bb clarinet”.

The A clarinet works the same way, but is three semi-tones below rather than two. Its music is transposed three semi-tones higher than it sounds in concert pitch. It is called the “A clarinet” because when it plays a notated C, a concert A is sounded.

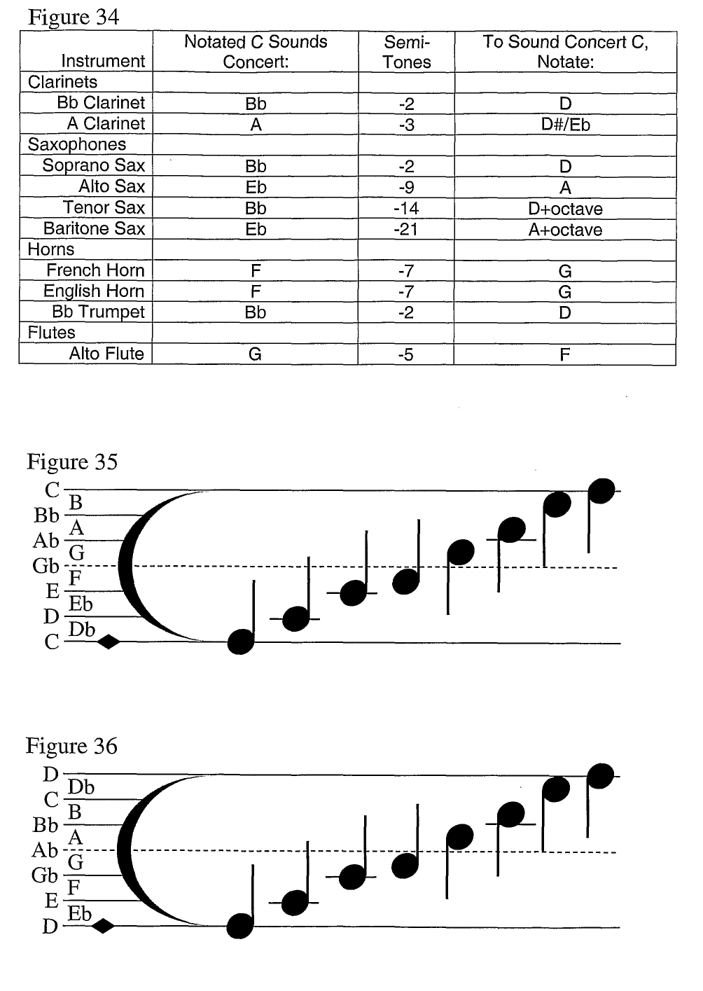

These clarinets are not a rare exception. FIG. 34 shows ten band and orchestral transposing instruments, indicating for each the pitch they produce when they play a notated C, the number of semi-tones away from concert pitch that their music is notated, and the note that must be notated for them to sound a concert C.

Basically, the notation of music for transposing instruments is a lie. It tells the Bb clarinettist to play in one key, while another key comes out. It tells a similar—but different—lie to the French Horn player, the alto flute player, the baritone sax player, and so on. Each of these instrumentalists imagines that she is playing in a key that is not actually the key of the sounds being produced. This erects a considerable impediment to musical understanding.

Having to maintain the parallel fictions of multiple keys is a significant impediment to music composition, arrangement, instruction and learning.

Another impediment arises as a side-effect: the incompatibility of each instrument's music with that of other instruments. If the soprano sax and alto flute player trade written music, the results will be out of tune with the rest of the band, because the key in which their respective music is written does not match. Thus, traditional music notation is “incompatible across instruments”.

As previously discussed, the Nota Graph system assigned C to the bottom line of the seven-line Nota Graph staff for all instruments, so that the concert C major scale would appear as shown in FIG. 35 (using the isomorphic staff and clef symbol for consistency with subsequent drawings). Because the transposing instruments need to notate different pitches from those played, this means that the notation of each transposing instrument's music is different from the others, which is not desirable.

However, if the vertical locations of the isomorphic staff were associated with different pitches for different instruments, such that the bottom line always indicated “the note that this instrument must play to sound a concert C”, then we would be a step closer to a solution.

To use the Bb clarinet as an example again, it must have a D notated to sound a concert C. Therefore the notation for the Bb clarinet—and all other Bb instruments, including most brass instruments, the soprano sax, and the tenor sax—would use the bottom line of the isomorphic staff to indicate D, so that the concert C major scale (played on Bb instruments as the D major scale) would appear as shown in FIG. 36.

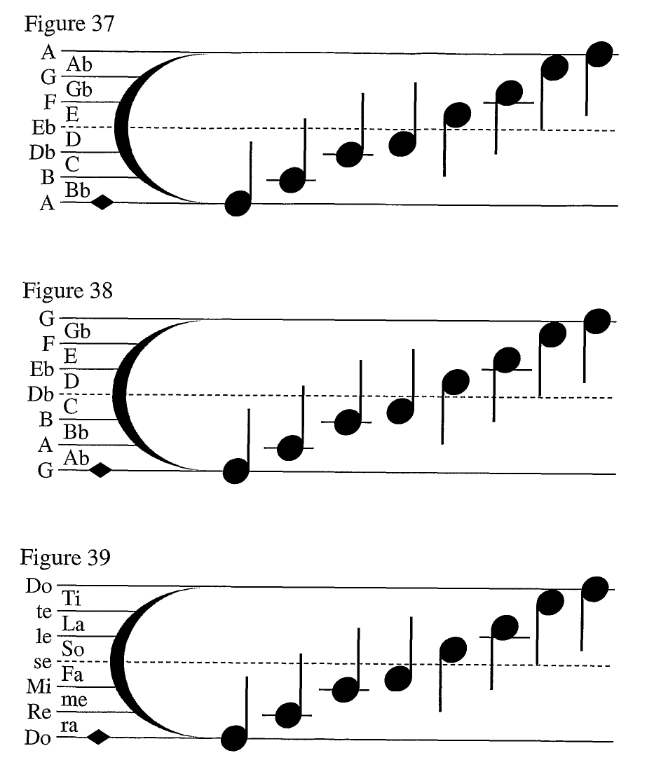

For Eb instruments, we would assign A to the bottom line, so that the concert C major scale (played on Eb instruments as the A major scale) would appear as shown in FIG. 37.

For F instruments, we assign G to the bottom line, so that the Concert C major scale (played on F instruments as the G major scale) would appear as shown in FIG. 38.

With these mappings of pitches to vertical locations on the staff, different for each kind of transposing instrument, acoustic instrumentalists could continue to play with the same note naming and fingering as they always had, but with notation that (a) exposes intervals consistently, (b) is the same in all octaves, and (c) looks the same for all instruments, no matter what the instrument's “native key”.

This is a considerable improvement over traditional notation, and it specifically solves the problem of “inconsistency across instruments”. Nonetheless, an impediment—and the lie from which it springs—remains. Teaching the different associations of pitches and staff locations would be difficult in a classroom setting, where the teacher is addressing the whole class, some of whose instruments are in C, some in Bb, some in Eb, some in F, etc. So, one more step is required to remove this final impediment.

That step is to associate the vertical locations of the isomorphic staff with Do, Re, Mi names. But this time, instead of using them to imply “movable Do” or tonic solfa, instead they imply “fixed Do”, also known as solfege. In solfege, Do is always concert C, Re is always concert D, and so on. Their pitches are absolutely fixed, rather than being related to the tonic as in moveable Do.

Therefore, for traditional instruments, “Do”, placed always at the bottom line of the isomorphic staff, would always mean “the note that must be played on this instrument to sound concert C”. For Bb, instruments, Do would be D; for A instruments, Do would be Eb; for F instruments, Do would be G; etc. The result is an isomorphic solfege staff.

The concert C major scale using the isomorphic solfege staff is shown in FIG. 39. (In these, as in all similar figures, it should be understood that the solfa/solfege names and/or pitch class names are not part of the staff, but are included only in these figures to indicate the pitch or interval values associated with the staff's vertical locations.)

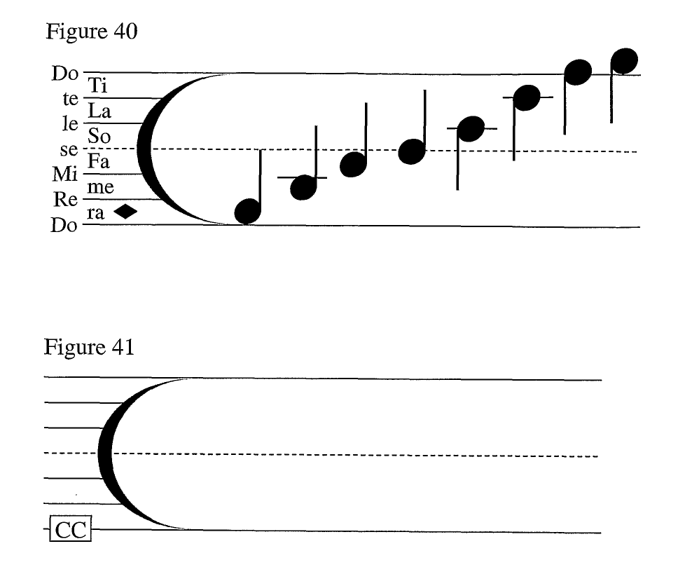

The concert C#/Db major scale is shown in FIG. 40. Note that its tonic indicator is on Ra (C#). This, combined with scale dots (not shown), through their pattern of intervals, would indicate the mode of the scale of which Ra is the tonic.

This final step removes the “lie”, by making it possible to teach the players of transposing instruments the simple truth that the Do-major scale is the concert C major scale, whatever it might otherwise be thought of. Similarly, the Ra major scale is the concert C#/Db major scale. Learning their staves and scales this way from the start would make their education considerably easier for all involved.

The isomorphic solfege staff differs from the isomorphic solfa staff in that the solfege staff's vertical locations refer to fixed concert pitches using their “fixed Do” solfege names, not intervals using their “moveable Do” tonic solfa names, although the names themselves (Do, Re, Mi, etc) are the same.

In the preferred embodiment of the isomorphic solfege staff, the text string “CC” would always appear on the Do-line, with a black rectangle surrounding it, as shown in FIG. 41. This black rectangle would indicate that “Concert C” (abbreviated “CC”) is “fixed” to that line. There is some potential for confusion between “CC” indicating the isomorphic solfege staff and “C” indicating the tonic in isomorphic solfa, but the difference is easily explained when initially encountered.

An alternative embodiment could be to use a slightly different clef symbol for the isomorphic solfege staff than isomorphic solfa staff. For example, a “unfilled” clef symbol (not shown) could be taken to indicate fixed Do (solfege) by convention, whereas the “filled” clef symbol as used in other figures could be taken to indicate moveable Do (solfa)—or vice versa. (Note that no such convention is followed in this document's figures, in which the solid form of the clef is used throughout.)

One of the greatest benefits of the solfa system is that it is consistent across keys. This advantage is not present in solfege. However, isomorphic solfege does provide the benefit of being consistent across instruments, in addition to being consistent between octaves, clefs and intervals, none of which is true of traditional notation.

The end result is that all instrumental music students would need to learn just one staff, with its association of solfa/solfege names to vertical locations. Composers, arrangers, and instructors would never have to transpose between instruments; every instrument's music would be notated the same, whatever its native key, clef, and/or octave; every traditional instrument's music could be read and played by players of all other traditional instruments without needing to transpose it.

Isomorphic Solfa for Alternative Tunings

While the 12-ET scale dominates modern Western music, other scales and tunings are also of interest. Because isomorphic solfa displays intervals using a consistent scale of cents, rather than traditional notation's inconsistent scale of pitch, isomorphic solfa is especially well-suited to the notation of alternative tunings.

N-Tone Equal Temperament Tuning

An equally-tempered tuning can be constructed for any division of the octave into N equal-width intervals (N-ET), with each interval's width being 1200/N cents wide. These N intervals are called “semi-tones” if N=12, since they are half the width of a 12-ET “whole-tone”, but this usage is confusing for other values of N. Therefore, in the following discussion, the interval that is 1200/N cents wide for a given N is called a “semit”, irrespective of the semit's specific width in cents (which differs for different values of N).

Diatonic interval names (eg, minor second, major second, etc) are used when reference to the intervals of the given N-ET's scale's diatonic scale is necessary, irrespective of those diatonic intervals' specific widths in cents (which also differ for different values of N).

Isomorphic solfa staves can be constructed to uniquely represent any N-ET tuning. Two such isomorphic solfa staves are discussed below—first 19-tone equal-temperament (19-ET) tuning is discussed below, then 17-ET. These tunings were chosen for discussion because each has a reasonable approximation of the diatonic scale, and have few enough buttons to fit within a reasonably small isomorphic keyboard.

N-Tone Solfa

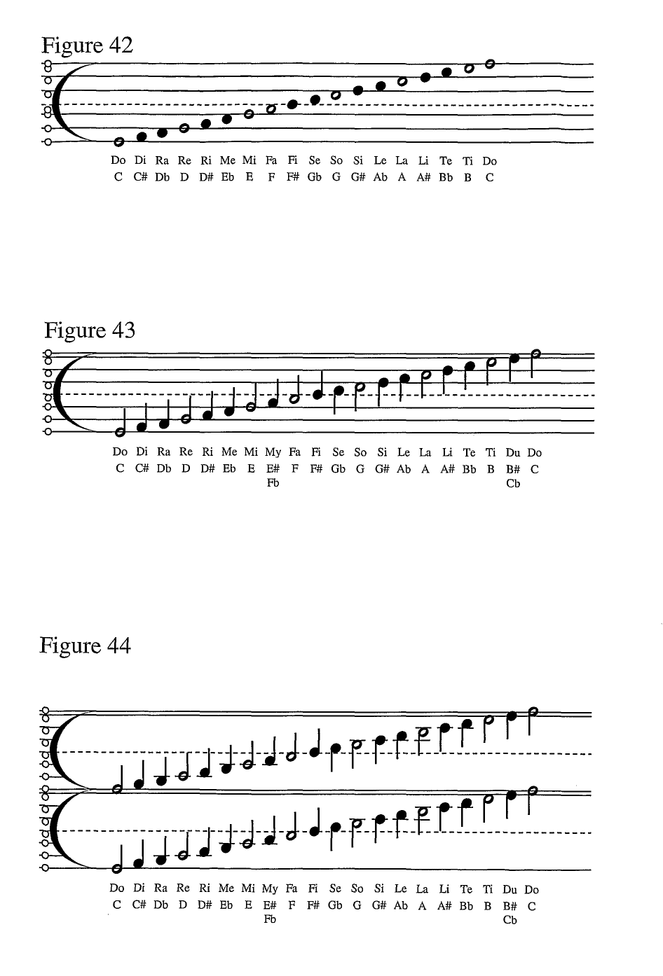

Each note in an N-ET scale needs its own unique solfa name. The names of the 17-ET scale's notes can be derived from the ascending and descending solfa names used in the Justly-intoned scale, as shown in FIG. 42. For 19-ET, two new solfa names can be created—My and Du—for notes that have no equivalent in 12-ET solfa (those occurring in between Mi and Fa, and Ti and Do, respectively), as shown in FIG. 43.

Note-Head Color

In the relevant figures, all diatonic notes are shown as “half-notes” (unfilled) whereas each scale's non-diatonic notes are “quarter-notes” (filled). This is done simply to facilitate the identification of the diatonic notes in the drawings, and is not necessarily a characteristic of the preferred embodiment of the present invention.

19-Tone Equal Temperament Isomorphic Solfa Notation

To extend the benefits of isomorphic notation to 19-ET music, two problems must be overcome:
1) the definition of a staff providing 20 unique vertical locations (one for each 19-ET semit, plus the octave); and
2) making the resulting staff periodic (the same in all octaves) despite the odd number of semits in the 19-ET scale.

A 19-ET semit is 63.158 cents wide (1200/19=63.158). In the 19-ET scale, major seconds are three semits wide, while minor seconds are two semits wide. In the preferred embodiment, lines are placed through every third semit in succession from the bottom Do-line places lines through 0 (Do), 3 (Re), 6 (Mi), 9 (Fi), 12 (Si), 15 (Li), and 18 (Du), as shown in FIG. 43. The Do-line then repeats (through semit 19), one semit higher than the Du-line. No notes fall between the Du-line and the Do-line in 19-ET.

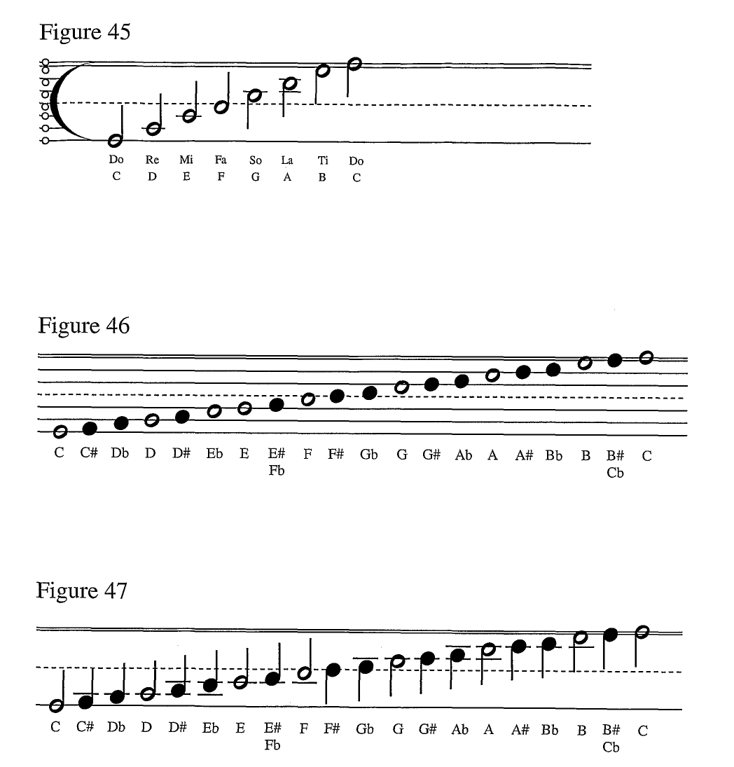

The result is a 19-ET isomorphic solfa staff. A fully-lined embodiment is shown in FIG. 43, and two stacked four-line staves in FIG. 44. The 19-ET diatonic scale is shown in FIG. 45. All are in authentic form, although other forms are equally valid under the present invention.

Other that the above-noted differences, isomorphic solfa notation is the same in 19-ET as in 12-ET.

It is hard to imagine that more many more than 19 tones can be placed on a single, useful isomorphic staff. An isomorphic staff for the 53-ET scale, for example, would take up more than twice as much vertical space as the two stacked staves shown in FIG. 44, just to display a single octave.

Note-Head Size

Because the octave is divided into more semits in 19-ET and 17-ET than 12-ET, these staves have to fit more unique vertical locations into the same vertical height. In one embodiment of the present invention, this can be accomplished by using smaller spaces and hence smaller note-heads, relative to 12-ET, on the same-sized staff, as is shown in FIGS. 43 and 44.

In another embodiment, one could use the note-heads that are the same size as they would be in 12-ET isomorphic solfa notation—hence “over-sized” for 19-ET —centred on the appropriate N-ET unique vertical staff locations. Rather than fitting neatly into their lines and spaces, the note-heads would extend slightly into adjacent vertical locations, as shown in FIGS. 46 and 47. More ledger lines are useful when using over-sized note-heads (as shown in FIG. 47) versus smaller note-heads (as shown in FIG. 44), to help distinguish one note from another in non-fully-lined staves.

In some of these figures, note-names are indicated along with or instead of tonic solfa names, to indicate that the present invention includes embodiments of the N-ET staff (for N not equal to 12) denoting pitch, in addition to embodiments denoting intervals. The absence of a clef symbol in FIGS. 46 and 47 indicates that a different clef symbol from that used in an isomorphic solfa staff should be used for pitch-based staves. Many pitch-based clefs have been proposed, and could be used in embodiments of the present invention.

17-Tone Equal Temperament Isomorphic Solfa Notation

Another N-tone equal-temperament tuning of interest is 17-ET tuning. As in 12-ET and 19-ET above, the crescent clef indicates the height of a single octave (from Do to Do), and the horizontal staff lines indicate intervals of interest (in cents).

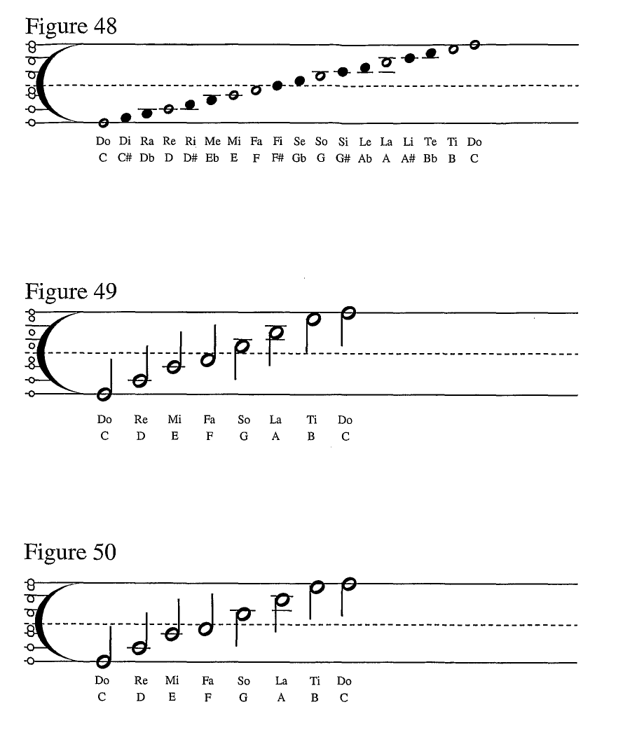

A single 17-ET semit is 70.588 cents wide (1200/17=70.588). In the 17-ET, the major second is three 17-ET semits wide, just as in the 19-ET scale. However, the minor second is only one 17-ET semit wide (narrower than in either 19-ET or 12-ET). In the preferred embodiment, lines are placed on the 17-ET staff through the semits 0 (Do), 3 (Re), 6 (Mi), 8 (Fi), 11 (Si), 14 (Li), and 17 (Do), as shown in FIGS. 42 and 48.

The Diatonic Scale in N-ET

By placing the staff lines slightly differently for each scale, as described above, the location and appearance of the diatonic scale's notes, including their ledger lines, can be kept substantially consistent across the 12-ET, 17-ET, and 19-ET scales, as shown in FIGS. 49, 50, and 45 respectively:
Do: on a solid line.
Ti: on the first full-width space below the Do-line.
La: bracketed between two ledger lines (although closer to the upper line in 17-ET and 19-ET than in 12-ET).
So: just above the dashed line.
Fa: just below the dashed line.
Mi: on a ledger line.
Re: on a ledger line.
Do: on a solid line.

An alternative embodiment of the present invention would place staff lines through all of the diatonic notes' unique locations (possibly via ledger lines), but not through any other notes. This embodiment would have the advantage of uniquely identifying the diatonic notes as “those notes with lines through them”. However, this same benefit—of uniquely identifying the diatonic notes—can be achieved through other means such as note-head coloration/filling as previously described.

Having some diatonic notes fall on lines, and some on spaces, indicates that Do, Re and Mi come from one “whole-tone row” (more generally, “wide-tone row”) while Fa, So, La, and Ti come from the other. This distinction also reflects the physical rows of buttons on many isomorphic keyboards (such as the Wicki/Hayden). This distinction is musically and pedagogically useful, and is made in the preferred embodiments of the isomorphic solfa staff as shown above.

Isomorphic Solfa Keyboards and Divisions of the Octave

Interestingly, in the isomorphic solfa keyboard layouts for 12-ET, 17-ET, and 19-ET, the diatonic scale note locations are identical. Therefore the diatonic fingerings, chord symbols, and solfa-based harmonic lattice (such as that shown in FIG. 32) are all precisely the same in 12-ET, 17-ET, and 19-ET. This consistency across different divisions of the octave has come as a complete surprise to those people with sufficient musical understanding to grasp the issues. It is easily explainable after first seeing it, but it is nonetheless surprising even to experts when first encountered.

The consistency of isomorphic solfa across divisions of the octave could make these alternative tunings much more accessible by the average musician. All of the music-reading and instrument-playing skills gained by a musician in 12-ET could be applied immediately to 17-ET, 19-ET, and potentially other divisions of the octave, without having to gain “sufficient musical understanding to grasp the issues”.

Unequal Divisions of the Octave

Many unequal divisions of the octave have also been defined—Pythagorean, meantone, Werkmeister III, Young's Well-Temperaments, etc. These are well-known to those versed in the musical arts, and can be usefully combined with isomorphic keyboards and tonic solfa. Constructing those combinations is trivial to those versed in the musical arts, so their construction is neither discussed not claimed herein.

Triangular Note Heads

Traditional staff notation is based on 3-limit (“Pythagorean”) Justly-intoned tuning, in which (for example) D# is not equal to Eb. In 12-ET, these two notes (and others like them) are “enharmonic equivalents”, meaning that they are just two different names for the same pitch. However, the notation of a D# vs Eb can convey useful functional information, such as whether the notated pitch is the result of diminishing or augmenting a diatonic interval. This information is also useful when adjusting the tuning of notes to fit Just Intonation during performance (by means that are not relevant to the current invention).

Isomorphic solfa can convey the same 3-limit information by the use of triangular note-heads, sized and colored similarly to the normally-shaped note-heads. Consider the interval between Do and Me. Is it an augmented second, or a minor third? In 12-ET, Me has the same pitch either way—but in Just Intonation it does not. Therefore, it would be useful to be able to indicate the distinction within isomorphic solfa staff notation, so that the player could, if means were available, adjust the pitch of the note to match its Justly-intoned tuning.

The preferred embodiment satisfies this need through the use of triangular note-heads which indicate which “non-enharmonic” tuning is intended. Continuing to use Me as an example, an upward-pointing triangle on Me would indicate an augmented second (in C Major, a D#), whereas a downward-pointing triangle on Me would indicate a minor third (an Eb). It is important to recognize that these triangular note-heads are variations on Me's note-head, not on Re's or Mi's. That is, the chromatic note's note-head is modified, NOT the diatonic note's.

In the preferred embodiment of 12-ET isomorphic solfa, the tonic solfa names of the non-diatonic notes are the “flat versions” of the tonic solfa syllables as previously discussed. However, when using triangular note-heads to convey 3-limit interval information, the upward-pointing triangles should be given the sharp name of the immediately-lower diatonic note, while the downward-pointing versions should be given the flat name of the immediately-higher diatonic note.

For example, an upward-pointing triangular note-head in the Me-space (indicating an augmented second above Do) would be called Ri (a sharpened Re), while a downward-pointing triangle in the Me-space (indicating a minor third above Do) would be called Me (a flattened Mi), if the traditional tonic solfa syllables are used as per the preferred embodiment. Other embodiments, using other naming conventions such as North Indian sargam, would name these notes accordingly.

The use of triangular note-heads gives isomorphic solfa staff notation precisely the same 3-limit denotational power that traditional notation has. However, even with this addition, isomorphic solfa staff notation is easier to use than traditional notation.

Consider a beginner, who—like most beginners—just “plays the staff”, ignoring all key signatures, accidentals, shaped note-heads, etc. “Playing the staff” with traditional notation will produce wrong notes if there are any sharps/flats notated at all—whether in the key signature or as accidentals. These notes will be “wrong” in any tuning—whether 12-ET or Just Intonation. However, “playing the staff” with 12-ET isomorphic solfa will ALWAYS produce the right 12-ET notes; all that is lost is information about modifying intonation from 12-ET to Just Intonation.

In conclusion, Isomorphic Solfa Music Notation provides an improved system of musical staff notation, chord symbols, keyboard note layouts, and harmonic lattices, which substantially resolves traditional notation's six inconsistencies in clefs, octaves, intervals, keys, instruments, and octave-divisions, making music substantially easier to teach, learn, and play.

1. A musical staff including:
a. a first axis on which time is represented;
b. a second axis substantially perpendicular to said time axis on which the width of musical intervals is represented with a continuous implied scale;
c. a means of indicating on said second axis the unique location of the interval “unison”;
d. a means of indicating on said second axis the unique location of the interval one octave higher than unison; and
e. note lines substantially parallel to said time axis which subdivide the space between said unison location and said octave location into a number of unique note locations that is equal to the number of divisions of the octave plus one, including note lines on said unison location and on said octave location, wherein each said note line is counted as one of said unique note locations, and
i. for even-numbered divisions of the octave,
1. said note lines are equally spaced, and
2. the space between each pair of said lines is counted as one of said unique note locations, and
ii. for odd-numbered divisions of the octave, said note lines are proportionately spaced, such that the space between any given pair of said note lines is wide enough to contain either zero, one, or two said unique note locations.

2. A musical staff as claimed in claim 1 in which said unison location and said octave location are indicated by a clef symbol or a portion thereof.

3. A musical staff as claimed in claim 1 in which said unison location is associated with a specified degree of the diatonic scale's Ionian mode.

4. A musical staff as claimed in claim 3 in which said specified degree of the diatonic scale's Ionian mode is the first degree.

5. A musical staff as claimed in claim 1 in which said clef separates a portion of said staff along said time axis from remainder of said staff along said time axis such that:
i. said note lines extend from the start of said time axis into the body of said clef;
ii. a subset of said note lines extend continuously beyond said clef; and
iii. the remaining said note lines extend discontinuously beyond said clef as ledger lines.

6. A musical staff as claimed in claim 5 in which said subset consists of said note lines indicating unison, unison's tritone, and any octaves thereof.

7. A musical staff as claimed in claim 6 in which said note lines indicating unison and any octaves thereof are drawn as solid lines and said note lines indicating unison's tritone and any octaves thereof are drawn as broken lines.

8. A musical staff as claimed in claim 1 unique note locations, appropriate for notating a 12-ET scale.

9. A musical staff as claimed in claim 1 unique note locations, appropriate for notating a 17-ET scale.

10. A musical staff as claimed in claim 1 unique note locations, appropriate for notating a 19-ET scale.

11. A musical staff as claimed in claim 8 in which said note locations are associated with the tonic solfa syllables Do, Ra, Re, Me, Mi, Fa, Se, So, Le, La, Te, Ti and Do respectively, from said unison location upwards.

12. A musical staff as claimed in claim 9 in which said note locations are associated with the tonic solfa syllables Do, Di, Pa, Re, Ri, Me, Mi, Fa, FI, Se, So, Si, Le, La, Li, Te, Ti and Do respectively, from said unison location upwards.

13. A musical staff as claimed in claim 10 in which said note locations are associated with the tonic solfa syllables Do, Di, Ra, Re, Ri, Me, Mi, My, Fa, Fi, Se, So, Si, Le, La, Li, Te, Ti, Du, and Do respectively, from said unison location upwards.

14. A musical staff as claimed in claim 8 in which said note locations are associated with the integers 0-11, from said unison location upwards, with said octave location also associated with 0.

15. A musical staff as claimed in claim 9 in which said note locations are associated with the integers 0-16, from said unison location upwards, with said octave location also associated with 0.

16. A musical staff as claimed in claim 10 in which said note locations are associated with the integers 0-18, from said unison location upwards, with said octave location also associated with 0.

17. A music notation system for graphical representation of a musical sequence or combination including a musical staff as claimed in claim 1.

18. A method for representing a musical sequence or combination the method including the steps of:
a. determining a note to be represented;
b. writing said note using a music notation system as defined in claim 1;
and repeating (a) and (b) until the musical sequence or combination is complete.

19. A method as claimed in claim 18 in which an existing musical sequence or combination is transcribed from traditional or alternative notation.

20. A method as claimed in claim 18 in which the note to be represented is determined visually, aurally or electronically.

21. A method as claimed in claim 18 in which an original musical sequence or combination is created.

22. A sheet of music upon which a musical sequence or combination is represented using the musical staff as claimed in claim 1.

23. A sheet of music upon which a musical sequence or combination is represented using the musical staff as claimed in claim 1.

24. Music represented on the musical staff as claimed in claim 1 in electronic form.

25. An isomorphic solfa sequencer notation system including:
a. a first axis on which time is represented;
b. a second axis substantially perpendicular to said time axis on which the width of musical intervals is represented;
c. a means of indicating on said second axis the unique location of the interval “unison”;
d. a means of indicating on said second axis the unique location of the first octave higher than said unison location;
e. lines substantially parallel to said time axis which intersect said second axis equally subdividing the space between said unison location and said octave location into a number of note spaces equal to a number of divisions of the octave;
f. the placement of bars within said note spaces indicating by their continuous presence the sounding, and by their absence the silence, of notes corresponding with said note spaces, relative to unison.

26. (canceled)

27. A system of chord notation including:
a. a unique symbol for each of the simple chromatic intervals from the minor second to the perfect fifth, in which each symbol is a mnemonic for either the shape of the interval on a specific isomorphic keyboard; or
ii. the number of 12-ET semitones in the interval; and
b. placing these interval symbols in sequence from lowest pitch to highest pitch.

28. A system of chord notation as claimed in claim 27 in which said interval symbols are selected from commonly available typographic symbols.

29. A system of chord notation as claimed in claim 27 in which the shape of a common chord on a given isomorphic keyboard is represented by a single typographic character created for this purpose.

30. A system of chord notation as claimed in claim 27 in which said sequence of symbols is prefixed by the name of the root pitch or interval.

31. A musical keyboard including:
a. an isomorphic layout;
b. a means of electronic transposition;
c. indicia to distinguish relative to the current electronically-transposed key:
i. each unique degree of the current diatonic scale; or
ii. each unique degree of the chromatic scale; or
iii. a two-way categorization into diatonic notes and non-diatonic notes.

32. A musical keyboard as claimed in claim 31 in which the diatonic scale's tritone-sounding notes at the edge of said keyboard are indicated as being chromatic.

33. A musical keyboard as claimed in claim 31 in which:
a. a first keyboard is provided for one hand;
b. a second keyboard is provided for a second hand;
c. at least one button on said first keyboard bears an interval-indicating indicia;
d. said note layout on said second keyboard is a mirror image of said note layout on said first keyboard;
e. said indicia on said at least one button of said first keyboard is likewise mirrored on the corresponding at least one button of said second keyboard.

34. A musical keyboard as claimed in claim 1 in which said indicia are tonic solfa syllables.

35. A musical keyboard as claimed in claim 1 in which said indicia are labeled with the tonic solfa syllables Do, Ra, Re, Me, Mi, Fa, Se, So, Le, La, Te, Ti in which Do corresponds to the first degree of the current key's Ionian mode and each successive syllable corresponds to a successively higher note in the chromatic scale.

36. A musical keyboard as claimed in claim 1 in which the indicia are the numerals 0-11 for a chromatic keyboard, or 0-7 for a diatonic keyboard.

37. A musical keyboard including:
a. an isomorphic layout;
b. at least one complete octave of buttons with 19 buttons per octave;
c. a means of electronic transposition; and
d. a means of selecting the division of the octave.

38. A musical keyboard as claimed in claim 37 in which at least the 12-ET or the 19-ET divisions of the octave can be selected.

39. A musical keyboard as claimed in claim 38 in which the indicia of the keyboard are appropriately labeled with 1 9-ET note names Do, Di, Ba, Re, Ri, Me, Mi, My, Fa, Fi, Se, So, Si, Le, La, Li, Te, Ti, Du with Di/Ra, Ri/Me, Fi/Se, Si/Le, Li/Te, My/Fa, and Ti/Du being enharmonic in 12-ET but different in 19-ET.

40. A musical keyboard as claimed in claim 31 in which the isomorphic keyboard is laid out such that:
a. at least two lines (“P5 lines”) are drawn to connect keyboard locations which sound successive perfect fifths, said at least two lines being separated by a major third;
b. at least two lines (“M3 lines”) are drawn to connect keyboard locations which sound successive major thirds, each intersecting said at least two said PS lines;
c. at least two lines (“m3 lines”) are drawn to connect keyboard locations which sound successive minor thirds, each intersection said at least two said P5 lines;
d. forming a lattice such that at least two triangles are bounded by the intersection PS lines, M3 lines and m3 lines;
wherein the notes of the keyboard corresponding to the vertices of each said triangle form a major or minor triad.

41. A musical keyboard as claimed in claim 40 in which said isomorphic keyboard's locations are associated with intervals such that the resulting lattice is the same in all keys.

42. A musical staff as claimed in claim 2 in which said unison location is associated with a specified degree of the diatonic scale's Ionian mode.

43. A sheet of music upon which a musical sequence or combination is represented using the musical notation system of claim 17.

44. A system of displaying musical intervals comprising:
a. the geometry of an isomorphic note layout,
b. fixed locations of the degrees of the diatonic scale, and
c. electronic and/or vocal transposition of pitches to scale degrees.

45. A system of controlling music intervals comprising:
a. the geometry of an isomorphic note layout,
b. fixed locations of the degrees of the diatonic scale, and
c. electronic and/or vocal transposition of pitches to scale degrees.
